(19) United States
(12) Patent Application Publication
(10) Pub. No.: US 2004/0208602 A1
(43) Pub. Date: Oct. 21, 2004

(54) Free space optical communications link tolerant of atmospheric interference

(76) Inventor: James Plante, San Diego, CA (US)

Correspondence Address: Joseph Page, Page Lohr Associates, P.O. Box 757, La Jolla, CA, 92038, US

(21) Appl. No.: 10/012,151

(22) Filed: Dec. 1, 2001

(51) Int. Cl. H04B 10/00

(52) U.S. Cl. 398/140

(57) ABSTRACT

Free space optical communications systems which resist atmospheric attenuation of optical beams is presented. Very long link distances remain highly reliable despite fog and other inclement weather conditions which otherwise tend to hamper optical transmissions in an atmospheric air column. Systems include primary elements as follows: a plurality of transceivers and at least one air column optical path. Each transceiver includes specialized light sources which produce radiation in the Mid-IR spectral region. In addition, these sources are very compact and well organized in view of their intended deployment environment. Further, special modulation means are joined with particular light sources to address high bandwith needs. In addition, specialized detection strategies are presented whereby sensitivity is improved. Alternative versions and configurations directed to specialized function are also described in detail.

### BACKGROUND OF THE INVENTION

1. Field

The field of these inventions described herefollowing may be best characterized as wireless communications links and more specifically Mid-IR free space optical communications links for conveyance of information.

2. Prior Art

Wireless links arranged for the conveyance of information signals are becoming commonplace due to new demands of digital information consumers. Indeed, Internet traffic and other digital media activity has recently shifted great attention to the development of very high bandwidth wireless networks for transmission of data.

A first important type of wireless link is used in networks common to mobile telephone systems. A network of radio transceivers provides connectivity services to users who may be moving about a coverage region; i.e. within range of radio transceivers. A mobile unit includes a radio transceiver which passes information encoded upon a radio carrier signal. Radio frequency radiation freely passes through the atmosphere without significant interruption from rain and fog or other weather related effects. However, systems using radio waves are intrinsically rather omni-directional. Radio signals from more than one system sharing the same space tend to interfere with other systems. As such, radio spectrum is highly regulated and carefully managed with great restrictions. Although data transmission links are arranged in radio spectral bands, systems of common wavelength cannot be easily used in shared space. Accordingly, radio spectrum cannot be freely used.

Another portion of the electromagnetic spectrum is sometimes used to establish communications links. Microwave type data links are commonly used to transmit information encoded on a microwave carrier. These systems are particularly useful in applications which require point-to-point connectivity such as transmission of television signal from a mobile television reporting station to a base station. Microwave systems are highly directional. As such, a common space may support several discrete data links even if two systems share the identical microwave carrier frequency and transmission space. Microwave systems have signals which tend to be rugged against path interruption. For example, when a bird flies through a microwave beam, a receiving station may not entirely lose the signal. A microwave beam is broad in width and easily penetrates certain materials and elements of weather such as fog. On the other hand, heavy rain sometimes interferes with microwave links. Microwave systems also suffer from regulatory issues and technical complexities which make their widespread use not possible.

Highly advanced wireless communications links have been created for special communications systems deployed in space. In particular, optical links have been devised to provide for satellite-to-satellite communications links. Obviously, a wireless link is required in most space applications. In satellite-to-satellite systems which are separated merely by distance and the vacuum of space, little or nothing interferes with a link's optical beam which may be quite small. A laser forms a superior light beam of high intensity and collimation or ‘spatial coherence’. These properties of laser beams make them ideal for optical links used in space for communication systems over great distances. Optical systems tend to require equipment of very high precision and finesse, thus these systems are generally very expensive.

Optical beam systems present great problems for links within Earth's atmosphere. A first major problem relates to the fact that water vapor contained in the atmosphere tends to absorb energy in the optical beam thereby extinguishing it. Other problems also associated with in-atmosphere conditions tend to suggest that optical communications links are more useful for outer space applications.

Despite these apparent problems and limitations, optical communications link systems have recently come to life as great demand for bandwidth drives advancement of the technology. In particular, systems where the infrared (IR) spectral band is used to as a carrier. Some IR semiconductor lasers are inexpensive and their use is highly unregulated. In addition, other related optical components are also becoming quite inexpensive. Because of these reasons, free space optical (FSO) communications links employing the IR spectrum for a carrier have been introduced with attractive success.

Although the future of FSO systems is quite promising, it is not without serious problems and limitations. Where optical communications links are used in the atmosphere, special considerations must be made for traversing the problems found with atmospheric attenuation. Presently, diode lasers are used to generate modulated beams of between about 0.7 and 1.6 microns in wavelength; sometimes known as near infrared wavelengths. Energy at these wavelengths is highly susceptible to attenuation by scattering from water particles and vapor in the atmosphere among other problems. In particular, FSO systems based on near infrared wavelengths fail in fog. Even light fog has a strong adverse effect on optical communications links of 1.55 micron. Fog is responsible for a very high attenuation factor with regard to near infrared wavelengths. In light fog, attenuation can be as high as 300 dB per kilometer. To traverse this problem, the distance between transceivers of FSO communications links is generally less than 2 kilometers even in clear air. In light fog conditions, a link may only be established over about 200 meters. In heavy fog, the beam of a 20 meter link is completely extinguished and the link fails entirely. Because attenuation is severe, even the higher power lasers sure to come in the future will not sufficiently overcome the problem. Experts in the field have resigned to the notion that 200 meters is about the maximum link distance and have designed their networks accordingly.

In one case, a strategy has been to build a mesh arrangement or a large plurality of nodes with short distances (approximately 200 meters) therebetween. In this way, a link remains active between nodes separated by even great distances because intermediate nodes remain in communication with those nearby on either side. The intermediate nodes pass information between them and onward toward a destination node far away. This may include many handoffs between various nodes. Consequently, the bandwidth of such systems is greatly consumed with repeated transmission of the same message between the plurality of nodes. Further, these mesh architectures require a great deal of equipment be deployed and maintained on regular intervals. This presents a very complex problem in environments such as a busy city business district.

In another scheme, a radio frequency backup is used. A near infrared FSO link works on clear days at great distances. When fog upsets the links, a system switches to radio energy beams which easy pass through fog. However, these redundant systems are expensive as they require considerable amounts of additional hardware. They are also difficult to implement in consideration of the required licenses for radio spectrum. Also, as mentioned, these systems tend to be omni-directional and interfere with similar links nearby. They additionally have serious security problems as it is quite easy for other to receive radio signals not intended to be shared.

Other solutions might simply tolerate interruptions in a low quality of service scheme whereby customers accept interruptions in service during times of bad weather. These systems may include links of considerable length, however, they only remain operative during times of clear weather. Where a high quality of service is demanded along with a link of great distance, there has heretofore been no solution.

In some applications where it is desirable to transmit an optical beam through atmospheres comprised of scattering elements such as smoke or dense clouds, middle infrared wavelength optical beams have been used. These include military applications of laser radars and other ranging type or imaging systems. Those systems benefit from the well known atmospheric windows, i.e. regions of the spectrum which propagate relatively unimpeded in most atmospheres, however they are highly specialized in their nature. Military applications tend not to be arranged around limited budgets and other constraints found in civilian applications. Some military applications of middle infrared optical systems are well supported with money and space and thus resulting configurations look very different than non-military systems. Military middle infrared systems have been quite successful in demonstrating that optical systems may be deployed in atmospheres which are smoky or otherwise not suitable for visible spectrum transmission.

Notwithstanding, techniques and devices have been discovered which provide very novel configurations of optical links, particularly with respect to those which may be used to establish a highly reliable link of great distance within the Earth's atmosphere. In contrast to the good and useful systems of the prior art, each having certain features that are no less than remarkable, instant inventions are concerned with providing highly reliable communications links durable against atmospheric components such as fog, pollution and particulate, among others.

### SUMMARY OF THESE INVENTIONS

Comes now, James Plante with inventions of free space optical communications systems highly tolerant of atmospheric interference including both devices and methods. It is a primary function of these inventions to provide highly reliable communication systems operating in environments comprised of undesirable conditions which tend to interrupt and attenuate optical beams. It is a contrast to prior art methods and devices that presented systems remain operable over very large link distances and retain high resistance against failure in the presence of haze, heavy fog, rain and other atmospheric components.

Apparatus of these inventions include basic elements as follows: a plurality of transceivers and at least one air column optical path. Of great importance with regard to arrangements of these systems is the lengths of the optical paths, i.e. the distance between any two transceivers. The distance may be quite large for two reasons. First, some preferred versions employ highly efficient and powerful lasers. Because high optical power is obtainable in certain lasers, the beam will propagate further through an absorbing medium like air in the Earth's atmosphere. Secondly, some preferred versions use light beams of radiation characterized as the middle infrared, Mid-IR, spectral region, in some cases about 10 micrometers in wavelength. These wavelengths are not strongly absorbed by components contained in air. Water, water vapor, smoke, and dust, among others, tend to only slightly effect Mid-IR optical beams in an adverse way. As such, free space optical links based on long wavelengths, i.e. wavelengths greater than about 3 microns and through 20 microns or greater, including the wavelengths of CO₂ lasers offer great advantages over those using near IR wavelengths below 3 microns.

Methods of these inventions include three important steps including: generating an optical carrier beam of middle infrared energy; encoding information upon that carrier beam transmitting the beam through a long optical path or column containing air; receiving and detecting the beam at a receiving station; converting data encoded on the beam to an electrical signal. By producing a Mid-IR optical beam and transmitting it through air over long distances, information encoded on the optical beam is passed to distant receivers even when heavy fog and other dense water vapor and other contaminants are present in the transmission path.

Fundamental differences between devices of the instant invention and those of the art can be found in consideration of its comparatively long carrier wavelength; long optical paths; weather resistant links; powerful compact lasers; fast modulators; very high speed cooled detectors, among others. These and other differences can be more fully understood and readily appreciated in view of the following detailed description.

### OBJECTIVES OF THE INVENTION

It is a primary object of these inventions to provide free space optical communications links.

It is an object of these inventions to provide highly reliable optical communications links.

It is a further object to provide optical communications links which remain functional in inclement weather.

It is an object of these inventions to provide optical communication links over large optical path distances.

It is another object to provide communications links having high bandwidth.

A better understanding can be had with reference to detailed description of preferred embodiments and with reference to appended drawings. Some embodiments presented are particular ways to realize the invention and are not inclusive of all ways possible. Therefore, there may exist embodiments that do not deviate from the spirit and scope of this disclosure as set forth by the claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is an illustration of an optical communications link of these inventions and its interaction with atmospheric components;

FIG. 2 is a similar illustration with emphasis on the transmission medium, a column of air;

FIG. 3 is a brief block diagram of communications links of these inventions;

FIG. 4 shows an example of major components of a communications link in a single direction in a schematic diagram;

FIG. 5 shows a detail of primary components of an optical head of the invention in a schematic diagram;

FIG. 6 illustrates examples of important light sources of these inventions;

FIG. 7 depicts a few examples of optical modulators appropriate for some preferred versions of these inventions;

FIG. 8 shows details relating to special detector configurations;

FIG. 9 is a block diagram to illustrate relationships of optical beams and some important components;

FIG. 10 is an optical layout presentation showing elements of an optical head and their relationships with a primary optic axis;

FIG. 11 is a similar optical layout presentation with further detail directed to important optical axes;

FIG. 12 is a cross sectional drawing depicting telescope spatial allocations;

FIG. 13 includes a ray trace presentation in the optical layout diagram showing important portions of beam propagation in the optical head;

FIG. 14 illustrates an important alternative version of telescope space is more carefully conserved and only two separate optical paths are present;

FIG. 15 shows the corresponding cross sectional drawing depicting telescope space;

FIG. 16 shows a spatial filter important in some versions and configurations;

FIG. 17 is a block diagram showing a special asymmetric version of a communications link in agreement with principles taught herein;

FIG. 18 presents amplification stages which may be used in some links comprising very long air columns;

FIG. 19 is a perspective cartoon to illustrate a problem related to communications links in a crowded community;

FIG. 20 is a block diagram to support description of a relay element;

FIG. 21 illustrates a special arrangement of temperature management elements which form a cooling system;

FIG. 22 shows a point-to-multipoint arrangement;

FIG. 23 is a schematic diagram depicting a layout in support of a wavelength division multiplexing arrangement;

FIG. 24 illustrates spatial separation of optical beams in support of a spatial division multiplexing arrangement;

FIG. 25 illustrates a special coupling in cooperation with a common office or home glass window.

FIG. 26 shows an alternative version of FIG. 25 with an angular provision.

### GLOSSARY OF SPECIAL TERMS

Throughout this disclosure, reference is made to some terms which may or may not be exactly defined in popular dictionaries as they are defined here. To provide a more precise disclosure, the following terms are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must use the context of use and liberal discretion to arrive at an intended meaning. One will be well advised to error on the side of attaching broader meanings to terms used in order to fully appreciate the depth of the teaching and to understand all the intended variations.

‘Mid-IR’ or Middle Infrared

Mid-IR radiation includes those optical wavelengths from about 3 microns to about 20 microns. For purposes of this invention, the Mid-IR portion of the spectrum is meant to include optical wavelengths between about 3 and 20 microns. With recognition that some writings may suggest different definitions for a Mid-IR region of the spectrum, the definition provided is useful for guidance in consideration of the concepts discussed. Where a particular wavelength is called out, it is intended that a linewidth exists where the wavelengths on either side of a center wavelength are also included. Some lasers presented herein have very unusually broad linewidths. For example: ‘9.5 microns’ might fairly represent 9.5 microns±0.5 microns.

Optical Beam Source

An optical beam source is a source of light suitable for arrangement in a beam via lenses or mirrors. An optical beam source may include both laser and non-laser devices. Although ‘lasers’ are used in most examples, it should be understood and recognized that a very special class of light emitting device which is not technically a laser may also work in some versions. Therefore strictly speaking ‘optical beam source’ should include both laser and non-laser type devices.

Detectors

Detectors are transducers responsive to photon input operable for generating an electronic signal either current or voltage. Thus, detectors of these inventions can be either photoconductive or photovoltaic. They may be either diode type devices or non-diode type structures.

Free Space

Although ‘free space’ may seem to imply space free of matter, recent common use suggests otherwise. Indeed, ‘free space’ as used here is in agreement with definitions where ‘space’ contains at least atmospheric air and perhaps other matter such as fog, haze, hail, snow, rain, dirt, dust, pollution, gases, currents, density gradients, among others. In this loose definition, free space is meant to be the absence of optical confinement by waveguides.

In addition to the terms described above, terms which are functional in nature may be more readily understood in view of the following notes:

Modulation Means

A ‘modulation means’ is a device arranged to cause a beam of light to be switched between two states one state being substantially lower in amplitude than the other state. In many embodiments of these inventions the modulation means is merely an electrical circuit which applies electrical currents to a semiconductor laser. The modulation means therefore performs the function of modulating the laser beam. Many forms of alternate modulators may be used to accomplish the identical task. The particular modulation means employed may be chosen for a particular task at hand, for example a Stark cell type modulation system would not be appropriate for a solid state laser; thus a switching current source technique may be preferred. A modulation means is selected for a particular application at hand. The essence of the invention is not changed by the particular choice of modulation means. Therefore versions of the invention should not be limited to one particular type. The limitation described by ‘modulation means’ is met when an optical beam is modulated. Therefore, by use of the term “modulation means” it is meant that any conceivable means for modulating an optical beam. Experts will recognize there are many thousands of possible ways of modulating an optical beam and it will not serve a further understanding of the invention to attempt to catalogue them here. The reader will appreciate that the broadest possible definition of “modulation means” is intended here.

Without repeating the preceding paragraph for all elements specified herein as ‘means’ plus function, or ‘means for . . . ’, it will be understood that a broad meaning is to be extended to those terms as well without limitation to examples which may appear throughout this disclosure. As it is the essence of the function rather than the precise nature of the structure of these devices which supports the invention.

### PREFERRED EMBODIMENTS OF THE INVENTION

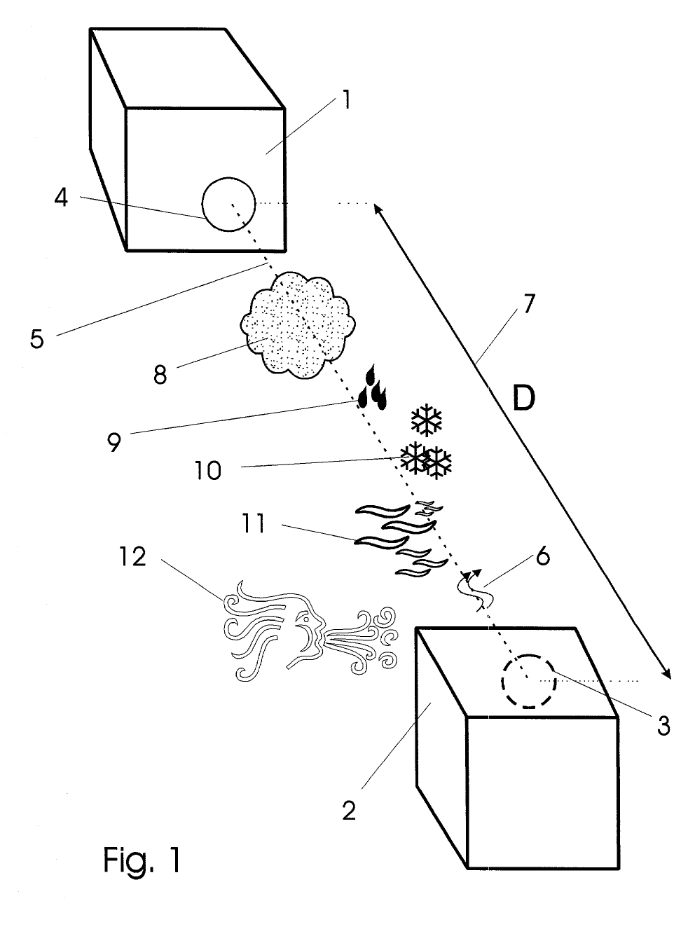

One will gain a firm and complete appreciation for details of the invention in consideration of drawing figures appended hereto and following descriptions of those figures. With regard to drawing FIG. 1 which is a generalized perspective block diagram showing major elements of a free space optical communications link highly resistant to interruption by atmospheric components. In particular, a first transceiver 1 is in communication with a second transceiver 2 by way of their optical ports or apertures 3 and 4. More precisely, a free space path along an optical axis 5 accommodates propagation of optical radiation 6 in the form of a light beam generated at either of the transceivers. The path is preferably cylindrical and some preferred versions have circular cross section. The free space path has a discrete length ‘D’ indicated in the figure by numeral 7. Further, the free space path may contain therein components unfriendly to the propagation of optical beams such as fog and water vapor 8, rain 9, snow 10, hail and other matter associated with inclement weather, floating particulate 11 including dust, smoke and pollution, air currents 12 such as wind, among others.

Transceivers of these inventions are coupled together by a free space path whereby the path length may be quite long in comparison to systems of the art. Prior art systems employing optical radiation of wavelengths less than 2 microns rarely have optical paths greater than 1 kilometer. At 1 kilometer, those systems are subject to very high failure rates and suffer catastrophic adverse effects from atmospheric attenuation. As a first response, those links using light of less than 2 micron reduce the optical path length and consequently those systems may only support optical paths of two hundred meters or less in highly reliable versions. Accordingly, air columns of these inventions have the useful property that they are exceptionally long without causing system failure. Under certain circumstances, a link may be established with an air column of tens of kilometers. In conditions accompanied by heavy fog, systems of the invention may support optical paths greater than a kilometer in length and remain fully functional and highly reliable.

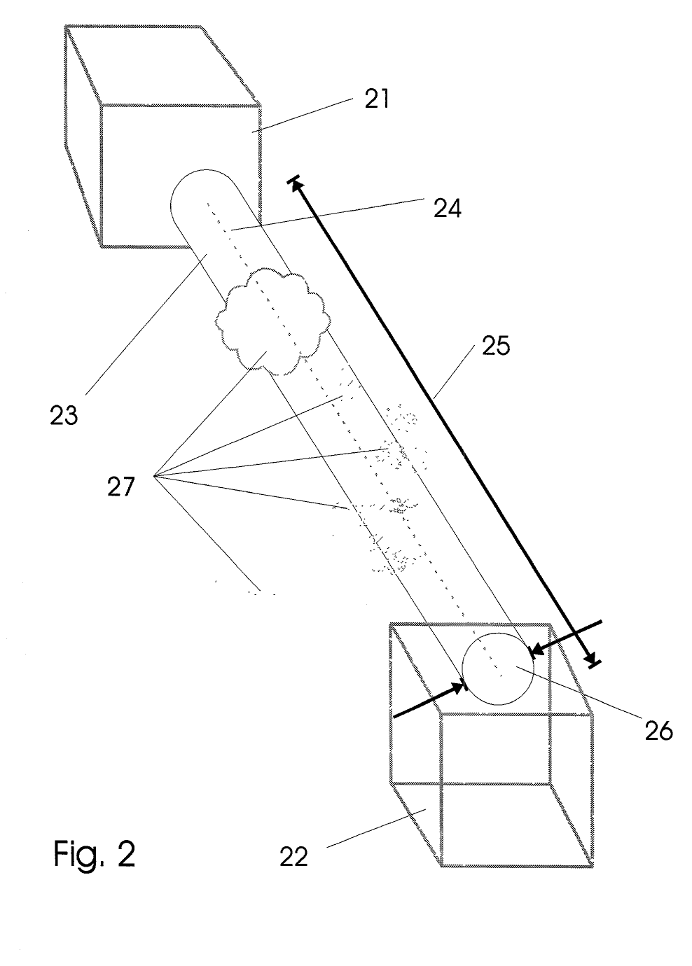

With reference to drawing FIG. 2, a transceiver 21 is a node of a single communications link. A second node, transceiver 22 is remotely located and separated from transceiver 21 with an air column 23 therebetween. An air column is the transmission medium of a Free Space Optics FSO communications link. Just as a glass fiber is the transmission medium of a fiber network and those fibers are characterized and arranged with great consideration for other system components, so are air columns of these inventions. Air columns of these inventions are characterized and arranged in view of the combinations of other systems elements. Therefore, an air column may be considered an important structural component of an entire system.

These air columns have a structural definition including an axis 24, a length 25 a cross section 26 shape and extent, among others. Air columns are also characterized by their composition. Although it is herein called an ‘air column’ it is in fact comprised of far more than just air. Both matter and other physical features should be considered as part of an air column. Physical features such as inhomogeneous distributions of matter, i.e. currents of gases and temperature gradients. Also, matter 27 such as water, dust, et cetera mentioned above. These characteristics and parameters are used to more fully define transmission media of these systems.

Water may be quantified in a density measure such as milligrams per liter. A more common measure is one of visibility having units in distance such as miles. Still further, hazy, light fog, medium fog, heavy fog, et cetera can be used to quantify water content of an air column. ‘Light fog’ can be associated with visibility greater than 2-3 miles. Attenuation of optical beams of 1 micron could be as high as 100 dB/km in ‘light fog’. A beam of 10 micron light however might only suffer an attenuation factor of 10 dB/km in the same light fog. ‘Medium fog’ restricts vision to between about 0.5 to 3 miles. Where medium fog is present, the air contains a moderate amount of water in particulate state; and those particles might have a more appreciable size. A near infrared optical beam of 1 micron might be attenuated at a rate greater than 100 dB/km but still less than 300 dB/km. A middle infrared beam might only suffer attenuation at a rate between 10 dB/km and 30 dB/km. ‘Heavy fog’ results in a visibility of 0 to 0.5 miles. The water content in the air is very high and the particles may be very dense and of a large size. A optical beam of 1 micron wavelength might suffer attenuation greater than 300 dB/km and thus be near completely extinguished in a very short distance. While in heavy fog, light of 10 microns might only be attenuated at a rate of 30 to 80 dB/km or in extreme cases about 100 dB/km. Thus, in heavy fog, a Mid-IR optical beam may still be used to form a useful communications link.

These characterizations are presented to project a rough feeling as to fog and its effects on light. Because fog is very different from place-to-place, and in various temperature states, and humidity conditions, the numbers above are not intended as an absolute measure of ‘visibility’, ‘fog’, or ‘attenuation’.

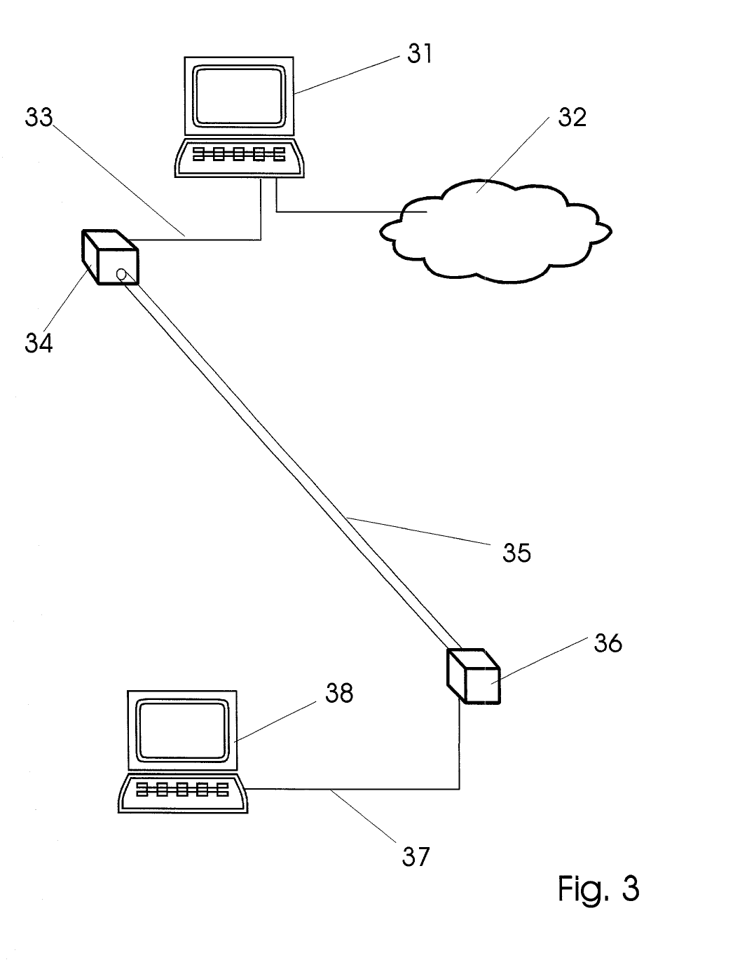

To more fully understand communications links of these inventions, it is useful to see how they might be embodied in common application. The Internet provides a universal and continuous connection to many millions of computers. To communicate with the Internet a user typically forms a connection through a ‘service provider’. Sometimes this is accomplished via regular phone lines, sometimes special subscriber data lines are used, sometimes a user connects via television style cable connections. In a less frequent case, a user might connect to a service provider via a fiber optic cable. The reason this is rare is because most locations where users employ computers are not equipped with fiber service. Those locations however are likely to have available a telephone line and users are limited to the slow service provided by telephone lines. An alternative connection to a network like the Internet could include a communications link taught here. FIG. 3 is a diagram showing a service host computer 31 in high speed communication with the Internet 32 network of computers. That service host may further be in communication 33 with an FSO communications link. A first transceiver 34 cooperates over an air column 35 with a second transceiver 36. That transceiver having a connection 37 to a client computer 38 completes the connection allowing a user direct and high speed access to any computer on the network.

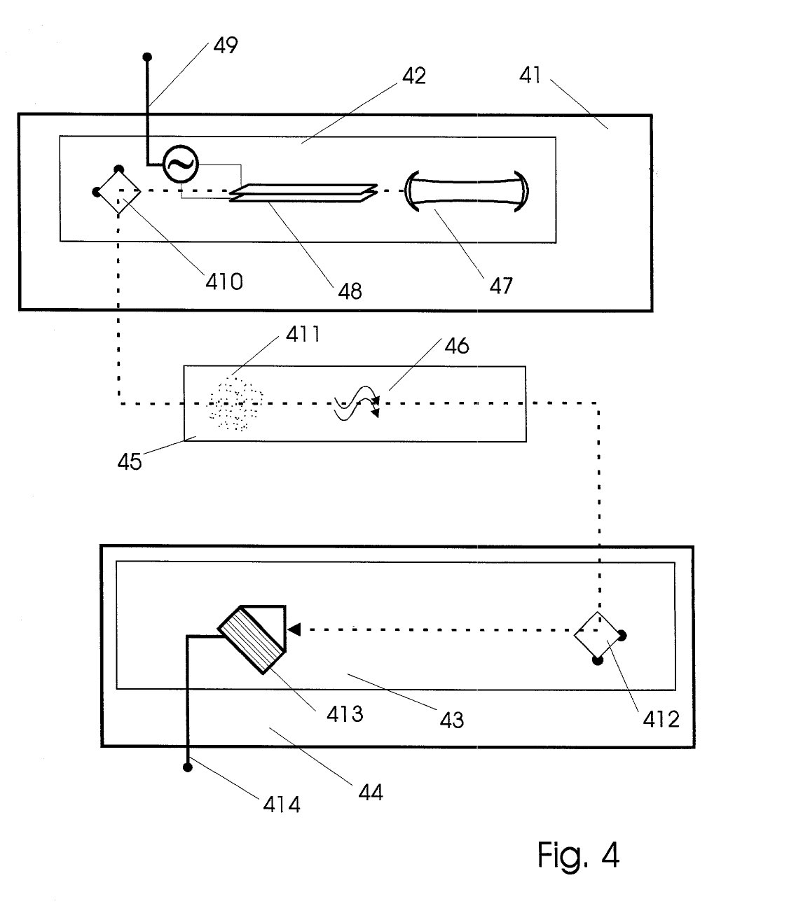

To more clearly understand how such an optics FSO link conveys information from one point to another one should consider components thereof. FIG. 4 is a schematic drawing to illustrate optical components which make up a point-to-point communication link in a single direction. A first node 41 includes therein a transmitter portion 42. Said transmitter is in communication with the receiver 43 of a second node 44 by way of a free space optical path 45 to form a communications link whereby information may be conveyed from the first node to the second. As mentioned, the free space optical path may be several kilometers in length and under special circumstances up to several tens of kilometers. A carrier beam of light 46 originates at a light source 47 and is modulated 48 in agreement with an electronic signal applied at node signal input 49. Steering mirror 410 couples the modulated optical signal into the air column free space optical path. The beam passes through water vapor and other components 411 from which the air column is comprised and becomes incident upon receiver steering mirror 412. Receiving steering mirror 412 carefully couples the received light beam onto fast detector 413 where it is collected and converted into an electronic signal which can be passed to and presented as electronic output 414.

It is possible as a special case to use principles of these inventions to realize a single direction only link where a node includes only one of either a transmitter or receiver. Thus, a long link which remains operable in fog and bad weather which is a single direction only link, is completely anticipated and is considered part of these inventions. Although the following examples are directed to transceivers having both a transmitter and receiver, that should not be taken to suggest that single direction Mid-IR FSO links are not part of this teaching. Quite to the contrary, it is explicitly stated here those types of systems are sometimes preferred as the following illustrative example suggests.

Where there is great asymmetry with regard to the extent of data to be conveyed, a single direction link is desirable. By omitting components required in bi-directional systems, devices can be made quite inexpensive. One can envisage a video-on-demand scenario where a user request merely comprises an index associate with a particular movie or a request having only several bytes of information. This several byte request may have associated therewith a many gigabyte reply, i.e. a presentation of a movie in multiple languages for example. Where the user has a receive only FSO link, the movie can be delivered without regard that an uplink is established via very meager means.

A reader will be well advised to maintain the notion that although best modes presented here are mostly bi-directional systems and that the inventors clearly mean to include Mid-IR FSO links in single direction systems too.

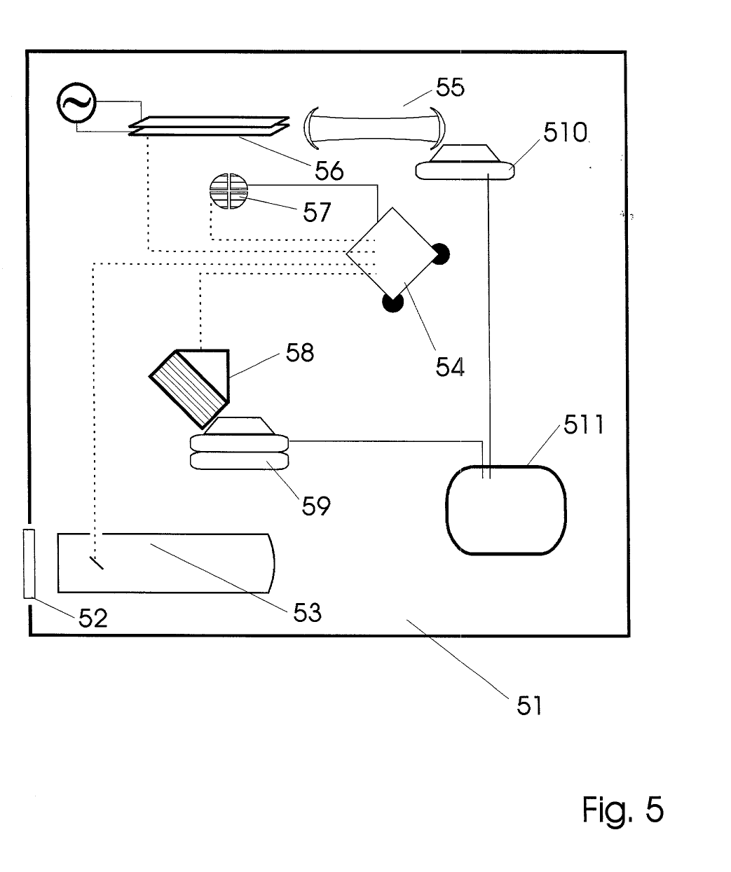

A more complete understanding of a preferred arrangement of the components of a single transceiver is shown in the drawing of FIG. 5. The figure is example of an optics head whereby important chosen components and their relationships with others are presented for increased clarity. A transceiver may have a strong and durable housing 51 suitable for containment of optics components therein. The housing is effective against contamination of its interior by dust and other matter. In addition, the housing and its contents are configured to reduce or prevent vibrations which can upset optical alignments. The housing has a port or aperture through which optical energy can pass. That port may be covered by a special barrier or window 52. The window can be a very thin film or alternatively made from a special composition allowing transmission of Mid-IR wavelengths. Telescope 53 collects incoming optical beams, condenses them and passes them to a steering mirror 54. Steering mirror 54 further couples three other subsystems as follows. Light source subsystems may include a laser 55 and modulator 56 combination to produce an encoded optical signal which is passed to the mirror and out the telescope. A first detector subsystem 57 includes a special detector to measure spatial conditions of received beams and to provide feedback to the steering mirror whereby it may be adjusted to improve the alignment of the entire system. A second detector 58 subsystem is a special highly sensitive and very fast, i.e. high bandwidth detector. The high bandwidth detector is preferably maintained at very low temperatures to improve sensitivity. This may be accomplished in some versions by way of a multi-stage thermo-electric cooling TEC system 59. Although a multi-stage system TEC is useful for attaining very low temperatures they can become problematic when the thermal load is high. Where a high thermal load and moderately low temperature is desired, a single stage TEC 510 may be sufficient. Thus, a certain semiconductor type laser which has those properties may be well served when it is coupled to a single stage TEC. Both single stage TECs and multistage TECs produce a large quantity of heat output which must be drawn away from an optics head configured as suggested. Thus, a special cooling unit 511 having an effective heat coupling to the TECs is arranged to carry away a large quantity of heat from those devices. These arrangements give very good advantage to transceivers used as Mid-IR FSO link nodes.

Although the previous discussions were more generally directed to system level topics, some of the following sections focus more closely on component level topics. For example, major components of a transmitter include a light source, a modulation means, and beam coupling means such as telescope and steering mirrors. Major components of a receiver include a detector and a telescope and steering system which may be shared with the transmitter. Each of these components may be choosen and specially arranged in a manner which advances the overall system objectives. This is made more clear as follows.

Transmitter

The transmitter portion of a transceiver preferably includes an optical beam source, and a modulation means. These may be coupled to a shared steering system and telescope. The following sections describe good candidates for optical beam sources and modulation means. In particular, attention is given to the combinations whereby certain optical beam sources combine well with certain modulation means. One should be careful not to assume that any combination left without address here as an example is not considered part of a possible combination which may have some good uses and thus not considered part of these inventions.

Optical Beam Source

Optical beams are used in Mid-IR FSO systems of these inventions to serve as carrier signals which can be modulated to carry information. Preferred optical beams used as carriers contain optical energy having a wavelength in the spectral region best described as Mid-IR; that is between about 3 and 20 microns. Thus, these optical beams are a typical as other free space optics communications links use optical beams having wavelengths less than 2 microns. Some experts in FSO systems would argue that light sources above 2 microns are unavailable or overly complex. Thus commercially available FSO systems are presently using light sources producing optical beams of less than 2 microns in wavelength; specifically both 0.850 microns and 1.55 microns. Early military systems may have attempted FSO communication links with 10.6 micron light from a CO₂ source but hardware difficulties relating to modulation, detection, laser all made these systems impractical and extremely expensive.

The Mid-IR region of the optical spectrum is particularly attractive for FSO systems for several reasons as follows. A natural artifact known as an ‘atmospheric window’ allows transmission of light at these same Mid-IR wavelengths with low losses. An atmospheric air column and components therin tend not to scatter light of some wavelengths. Also, constituent gases present in an atmospheric air do not include those which absorb Mid-IR light. Further, long wavelengths reduce effects of speckle or scintillation which can be problematic for most coherent light applications. Still further, some intense laser beams of shorter wavelengths are unsafe as they can damage the eyes of humans and animals. However, even very bright beams of Mid-IR radiation are safe because they are not transmitted through the eye to sensitive tissue; thus high intensity Mid-IR beams are more eye-safe than shorter wavelengths. In addition, effects of Mie scattering is lower for wavelengths large in comparison to scattering particles; the average size of particulate in the atmosphere is on the order of one micron. Raleigh scattering is inversely proportional to the fourth power of the wavelength and thus systems having long wavelengths are highly favored compared to those of short wavelengths. Other forms of scattering are also reduced for longer wavelengths. In brief, Mid-IR wavelengths present many advantages for transmitting light through a free space air column. However, these advantages come at a price.

Until very recent discoveries, some of which remain quite unknown in many fields, there was little or no choice for Mid-IR light sources, modulators, detectors, and optics which would make a commercial system practical. Consequently, practitioners of FSO system design would be greatly discouraged from taking an approach which employs Mid-IR wavelengths; and in fact, they have not.

For example, common CO₂ lasers have many complexities without obvious solutions in view of their application to commercial FSO requirements. CO₂ lasers are bulky, temperamental, short-lived, high in maintenance, and expensive. For these reasons, one should be encouraged to avoid using a CO₂ laser as a light source. To date, inventors of more practical FSO systems invariably choose the IR semiconductor laser at 1.55 micron for its simplicity, power, low cost, and ease of use. Failed experiments relating to some FSO systems employing CO₂ lasers probably conducted by the United States military further prove this point. For all of these reasons and others, CO₂ lasers are not presently being used for light sources in practical FSO systems. Similarly, modulators required in FSO schema are simply not readily available. Typical modulators are slow and require too great of power. Further, difficulties with required optic elements strongly suggest avoiding this tack.

However in contrast to what is obvious, possible candidates for Mid-IR FSO light sources include highly specialized quantum well solid-state lasers that produce exceptionally high intensity Mid-IR beams. These devices are sometimes known as ‘quantum cascade lasers’ QCLs. QCLs are presently little more than laboratory experiments and are not well known outside the immediate field described as ‘quantum wells having intersubband transitions’. Further, another Mid-IR FSO light source candidate also includes a newly developed RF-excited, folded-cavity CO₂ gas laser. This high performance laser is compact, inexpensive, stable and may serve well Mid-IR FSO link requirements. In both these special cases, laser configurations cooperate with the highly specialized task at hand, that is an inexpensive, commercially deployable, high power Mid-IR source without complex supporting apparatus and machinery.

Solid State Lasers

Although common diode lasers or ‘bandgap’ lasers do not support lasing at Mid-IR wavelengths of appreciable power, there are some very interesting candidates of semiconductor devices having remarkably different operation mechanisms which may produce high power Mid-IR optical beams. A first laser of great importance is the newly invented quantum cascade laser. A physical structure called a ‘quantum well’ is formed to manipulate discrete energy levels allowed by electrons in the conduction band, for example, of semiconductor material. QCLs have been produced to lase at wavelengths between 3 and 70 microns and exhibit very high power, greater than 20 milliwatts continuous wave at room temperature.

These devices are sometimes characterized as ‘intersubband’ devices. The lasing energy transitions both upper and lower level are within the conduction band, thus ‘intersubband’. This stands in strong contrast to common diode lasers which are bandgap devices because transitions occur between a conduction and valence band.

Still further, devices which are not intersubband, but rather interband, are also provided with quantum well manipulation of allowed energy levels. Radiative transitions occur between a conduction band and a valence band similar to traditional bandgap devices, however the precise part of the band in which a transistion occurs is manipulated via appropriate design of quantum wells. Sometimes these devices are called Type II quantum well cascade emitters. They differ from diode lasers in that the allowed energy levels within the conduction and valence bands are manipulated by way of the quantum well structures.

Although focus is placed on the more developed type I devices, i.e. the QCL, it is explicitly asserted here that Type II devices offer interesting advantages which can be integrated nicely with some Mid-IR FSO objectives and use of these types of devices is fully contemplated here.

Quantum Cascade Lasers QCLs

For a brief review of quantum cascade lasers see U.S. Pat. Nos. 6,148,012; 6,144,681; 6,137,817; 6,134,257; 6,091,753; 6,055,254; 6,023,482; 5,978,397; 5,936,989; 5,901,168; 5,745,516; 5,727,010; 5,570,386; 5,509,025; 5,502,787; 5,457,709; 5,311,009; and 4,999,697, where a firm appreciation for these devices and their benefits may be found. Those documents are hereby incorporated into this disclosure by reference.

A quantum cascade laser, QCL, is a solid state laser quite different from conventional solid state lasers. A common solid state laser produces a photon when a charge carrier of the negative type (an electron) annihilates a charge carrier of the positive type (a hole). As there is an associated energy gap between these bands, an equivalent energy is released as the emitted photon. Therefore these lasers are sometimes known as ‘band-gap’ lasers. A QCL is a solid state laser of remarkable difference and does not operate in a ‘band gap’ mode.

Conversely, electrons confined in quantum wells of a QCL may pass into other energy states only under very strict conditions. For some transitions, one of those conditions is that energy in the form of a photon is released in the transition. The careful observer will note that electrons trapped by quantum wells may experience transitions between energy states and never leave the band (most frequently the conduction band). By careful regulation of the physical conditions which form a quantum well, a laser is created with remarkable characteristics. Because intersubband transitions of these type are very low in energy in comparison to a common solid state laser, the resulting optical beams can be of much greater wavelengths than those of band gap lasers. Band gap lasers do not produce radiation much above 1.5 microns because there are few if any semiconductor materials which could form such a small band gap and still support the laser function efficiently.

Advantageous characteristics of QCLs include exceptionally high power in the Mid-IR spectral region. As mentioned, it is the material composition which regulates the energy of photons produced by band-gap lasers. In stark contrast, QCLs of all wavelengths may be fashioned with identical materials to produce wavelengths over a large range; 3-70 microns and theoretically greater lengths. This is due to the fact that the quantum wells are dependent not on the semiconductor material type but rather on the physical geometry of material layers. Where a conventional solid state laser makes a few milliwatts of power in the Mid-IR spectrum, a QCL may make 500 milliwatts. Accordingly, high power attainable with QCLs suggest them as a good candidates for applications demanding high power. As this laser is relatively new and unknown to many, experts in FSO systems have elected to build their systems around conventional solid state lasers in the spectral bands near 0.85 or 1.55 micron.

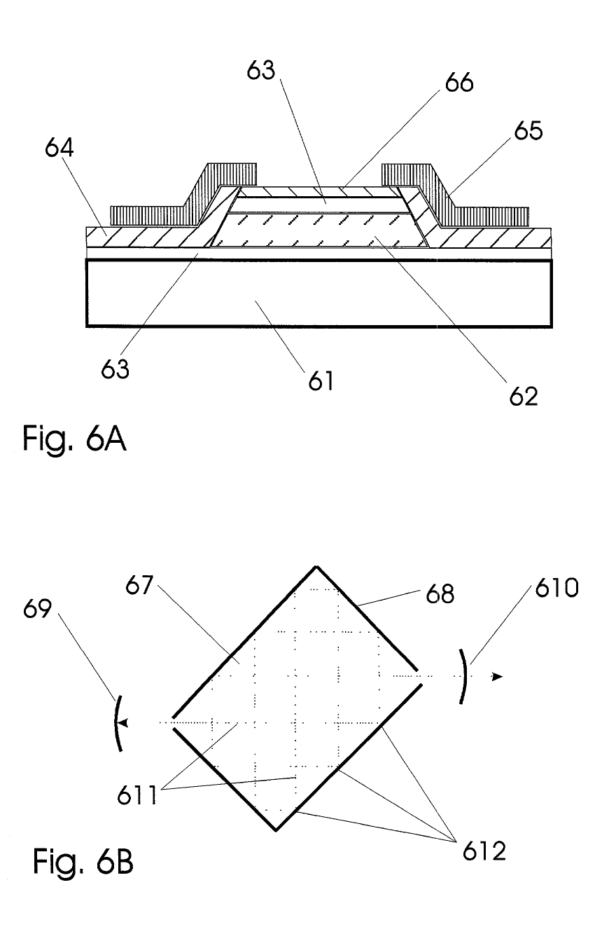

A preferred geometry of a QCL laser useful in FSO applications is presented in drawing FIG. 6A. A substrate material 61 of InP forms a base onto which layers may be grown via processing techniques like molecular beam epitaxi MBE and metal oxide chemical vapor deposition MOCVD.

A very special layer known as the ‘active region’ 62 is a stack of quantum wells. Quantum wells are formed when similar crystals of slightly different materials form a sandwich. For example, GaAs and AlGaAs layers can form a quantum well. The width of a GaAs layer sandwiched between two AlGaAs layers controls allowed energy levels an electron may occupy via its associated deBroglie wavelength. The electron is ‘bound’ in one dimension and thus has a stable state while trapped in the well. A wave function describes the probability an electron will tunnel through a barrier layer and arrive in another well with another energy state. QCL lasers are made of a repetitive structure of wells and barriers. Still further, they are made of a repetitive structure of active regions and injector regions. These regions dictate the behavior of the electrons passing through the layers as current as each region is configured to cause certain energy transition events to occur. An injector region helps to realign energy levels so that an electron may more easily enter the excited state of the next active region. An active region provides the upper and lower lasing energy levels and sometimes a special third level to help further depopulate the bottom lasing level creating a stronger inversion necessary for high power lasers. For purposes of explaining the diagram, we will recognize that the portion marked 62 contains a stack of wells and barriers to form the laser active layer. When light is emitted from the active layer in lasing transitions, it is desirable to contain that light and cause it to propagate further in the material. Thus, the laser active layer is surrounded top and bottom with a material 63 to form a waveguide or cladding. Guard 64, an insulator, provides electrical isolation between the laser layers and electrical contacts 65. A lateral contact layer 66 may be used is some versions as a grating (as in distributed brag feedback devices) or simply to provide a conductive path for current flow into the cladding layer. In some versions, this layer may be omitted entirely.

The QCL has yet important advantages in view of objectives desirable in FSO communications links. These include speed, lifetime, ease of manufacture, high temperature operation, among others. The following sections direct attention to further advantages of using QCL devices in FSO systems.

Because a primary objective of a FSO system is to convey information on an encoded beam of light, the maximum speed at which one can encode the beam, or bandwidth, is very important. Thus, the suggestion of QCL use in FSO systems is an important one because cooperation with regard to speed is strong. Since recombination mechanisms are phonon, rather than Auger type, QCL devices are extremely fast. They may be turned ‘on’ and ‘off’ in single picosecond times and display little or no decay between pulses. Some theorists predict that a QCL could be modulated at 10 GHz; an extremely fast switching speed even in comparison to many modem switching devices.

Although QCLs have serious power and heat limitations, great progress has been made via special arrangements of structures. To date, it has been nearly impossible to achieve high power room temperature operation of continuous wave lasers. This is due to high threshold currents which must be applied to QCLs to reach the lasing conditions. For preferred versions of FSO communications systems, it is of great importance to arrive at a laser which operates without complex cooling. One important improvement relates to efficiency with regard to room temperature operation. In a laser comprising energy transitions between upper and lower energy states, it is sometimes possible to manipulate the populations of these energy states to increase the inversion and thus increase lasing efficiency. In one preferred QCL scheme, the lower lasing energy level can be ‘depopulated’ by creating a special arrangement of quantum wells to provide a stepped mechanism to draw electrons from the lower states. Electrons leave the lower lasing state by a phonon scattering event. A quantum well can be provided to support a temporary energy state whereby electrons pass easily from the lower lasing state into the temporary state before passing to the next stage in the cascade. This extra energy state allows the lower lasing state to become emptied with greater efficiency thus creating a stronger inversion. In this way, QCLs have been made to lase at room temperature with appreciable output power. Thus the combination of these types of QCLs and FSO systems is an important one because FSO systems are preferable arranged with simple cooling apparatus or no cooling apparatus at all.

QCLs are very compact and robust. They have exceptional lifetime in comparison to gas lasers which have decomposition problems with chemistry along with many other problems. Although preliminary lifetime tests indicate the device has very long operational lifetimes, these tests are incomplete due to the lack of maturity; QCLs have only been in existence a few years. However, it is known that common semiconductor lasers suffer from problems having their origin in the junction. Junction breakdown limits the useful life of bandgap or diode lasers. QCLs do not have this problem as there is no active junction. Although crystal junctions exist in QCLs, these do not have the properties of a bandgap junction which is accompanied by defects and breakdowns seen in those types of lasers where electrons and holes recombine.

FSO systems deployed in the field will require ruggedness against impact and shock forces. QCL solid state devices do not suffer from impact damage and thus have exceptional lifetime when compared to other optical sources.

While conventional semiconductor lasers come in many wavelengths, and are in fact sometimes tunable over large spectral bands, they do not cover the extent of spectral bands achievable by QCLs. In consideration of FSO systems, this is important because wavelength division multiplexing strategies may require a plurality of lasers each of which operate at slightly different frequencies than the others. This is readily achievable in QCL without the complex physical devices such as distributed Bragg gratings and other feedback filters employed in standard semiconductor lasers.

Another important advantage in the combination of QCL lasers with FSO communication links is realized via the peculiar breadth of the lasing linewidth. In a bandgap laser, the energy associated with the bandgap can be well defined giving those lasers a narrow linewidth. While in most applications a tight linewidth is a great advantage, this is not so in FSO communications systems where total power is more important than spectral purity. The repetitive structure of a QCL allows in some cases more than 35 stages. Each of those stages can have a slightly different energy transition associated therewith thus greatly broadening the laser gain profile. This is unique to QCLs and is not found it diode type lasers. Thus the line width of a QCL based FSO systems can have favorable total power characteristics distributed over a broad linewidth. Although not common, in some cases the linewidth of a QCL is 500 nanometers.

Materials used to form QCLs are readily available and in common use today in most semiconductor foundries. These materials are inexpensive, found in necessary purity, well known, reliable, and easy to manipulate with great precision. Therefore, the manufacture of QCLs for use in FSO systems is straightforward and may be done on a mass scale. Thus QCLs are to be considered a primary candidate for Mid-IR FSO systems and this combination has heretofore not been made.

Although QCLs offer many interesting advantages, it is not always necessary to use these types of lasers. Indeed, some preferred versions of Mid-IR FSO systems do not require benefits afforded by semiconductor lasers. Improvements to gas lasers have made their use possible in ways previously dismissed as impractical. For example, new CO₂ lasers are now made to be quite inexpensive, with low maintenance, highly compact and efficient. Therefore, use of these versions of new CO₂ lasers when combined with an office deployable FSO communications links makes a novel and useful combination.

CO₂ Lasers

To produce an optical beam of one of the preferred wavelengths, use of a CO₂ laser is desirable. The advantages of using a CO₂ laser as an optical source in an atmospheric free space communications link are two fold: first, even small CO₂ lasers are powerful and efficient; secondly, a CO₂ laser produces radiation which is not readily attenuated by atmospheric components. Thus, optical beams produced by CO₂ laser sources penetrate long air column optical paths comprising large amounts of scattering and absorbing material to reach a detector and carry a modulation signal thereto. A preferred optical source of these inventions is compact, rugged, sealed, RF excited, folded, single mode.

Very newly developed CO₂ lasers include specially arranged folded cavity devices. With reference to drawing FIG. 6B, a cavity 67 in the shape of a rectangle having four interior walls 68 of highly reflective surfaces is arranged with a high reflector spherical mirror 69 and a output mirror 610. A ray trace 611 illustrates the path of a beam which is bounced many times within the rectangular cavity before exiting at the output mirror. Well planned reflections 612 from interior walls assure that a beam is aligned with both mirrors and the cavity supports a Gaussian beam, including single line single mode as well as multi-line multi-mode, as a common linear cavity would. The cavity may be a sealed cavity whereby gas flow issues are removed. Further, the gas can be excited by an RF energy pump.

In a first special arrangement, a CO₂ laser is configured to better cooperate with planned air columns. Since the transmission medium contains naturally occurring CO₂ molecule, it will tend to absorb the carrier beam. To avoid this undesirable effect, a special type of CO₂ gas laser is suggested. Where the best possible atmospheric transmission is desired, a isotopic CO₂ can be used as the lasing medium. The isotopic CO₂ will have lasing frequencies slightly shifted from natural CO₂. Thus the atomic resonance of atmospheric CO₂ will not be aligned with the laser energy and absorption will be reduced. Therefore, considerable advantages can be realized when isotopic CO₂ lasers are used as a light source in Mid-IR FSO communications systems.

A CO₂ laser has yet another advantage. These lasers can be made with exceptionally high power outputs. As such, they will support the special configuration whereby one transmitter is in communication with many receivers. A ‘point-to-multipoint’ system could be built around a single very powerful CO₂ laser. Such an arrangement also supports various asymmetric strategies presented later in this disclosure.

Modulators

To convey information from one place to another in communications links, information is generally encoded onto a carrier signal. A modulator operates to encode a uniform optical carrier beam with information to be conveyed. Common schemes include both frequency modulation and amplitude modulation. In some preferred versions of these inventions, amplitude modulation techniques are preferred while recognizing frequency modulation may offer alternative possibilities. For descriptions of preferred versions, amplitude modulation schemes will be used without limiting the devices to those techniques. An optical beam is said to be amplitude modulated if it comprises a series of amplitude pulses, in digital systems the pulses may represent discrete binary states; or an ‘on’ condition and an ‘off’ condition.

In some systems direct modulation is achieved by simply turning ‘on’ and ‘off’ a beam source. Alternatively, a uniform beam may be modulated if a modulator is coupled to the output of an optical source, for example the optic axis of a beam source is aligned with the optic axis of a modulator such that the beam propagates into a modulator input aperture and out an output aperture, and therebetween the bulk modulator interacts with the beam to interrupt it in some prescribed manner. A modulator can attenuate a beam to impress thereupon information desired to be conveyed.

Modulators of these inventions are quite different than common modulators. Most optical modulators will not work at infrared wavelengths and more particularly at Mid-IR wavelengths. For this reason, these inventions include some specific arrangements of modulation means which will work in the Mid-IR spectral region.

In addition, some of these inventions require extremely high bandwidth modulation. Common modulators may not be able to modulate an optical beam at the speed demanded by these applications. Thus, particular modulators unique to the FSO objectives are used and these modulators are unlike common modulators used in other applications. For some versions, modulators must be fast enough to provide modulation at a 0.1 to about 10 GHz bandwidth. Those familiar with a relatively slow acousto-optic type modulator will immediately understand that systems of these inventions demand very specific types of modulation strategies.

Three Examples

There are at least three preferred ways to modulate optical beams of these inventions. Included among these three are direct modulation, solid state modulation via an electro-optic effect and finally gas type modulation via a ‘Stark effect’. With regard to these FSO applications, there exists an important modulator-source correspondence. Although not necessarily a strict correspondence, it is easier to understand Mid-IR FSO modulation techniques in the arrangements described here as sources are matched with modulation means of various types. Thus, certain modulators of these inventions are coupled and arranged to cooperate with certain optical beam sources.

A first example is applicable to a solid state semiconductor optical beam source. In systems having QCLs or other semiconductors as a beam source, direct modulation may be considered best. A very fast voltage or current source may be pulsed whereby lasing is effected in correspondence with applied voltage or currents. Where gas type lasers such as CO₂ lasers are used, the laser output may be coupled to a solid state modulator in various configurations. By way of an electro-optic effect, the beam is modulated. In some configurations a gas type Stark cell modulator device is possibly an effective modulation means. Details of these three types of arrangements follow. The careful reader will be reminded the most important physical characteristics of a modulator arranged to serve FSO objectives is that it is fast and operates to modulate Mid-IR light. Thus the true scope of these modulator components should be defined by those parameters rather than any found in the examples which are only provided for clarity.

1) Direct Modulation of Semiconductor Laser

Because high speed conveyance of information is a top priority for Mid-IR FSO communication links, a fast modulation mechanism is a critical consideration. Solid state lasers enjoy the benefit of direct modulation whereby applied current is simply turned on and off, or pulsed, to cause the laser to emit light pulses in agreement. Some solid state lasers are highly responsive to applied currents and will follow these applied currents without appreciable latency. Thus, certain solid state type lasers can be switched at a very high frequency. QCLs are an example of devices highly responsive to applied current and thus are switched with exceptional speed. Indeed, at least one theoretical prediction suggests these lasers can be switched at rates in the tens of Gigahertz. Accordingly, in systems employing QCLs a direct modulation scheme is adopted to realize very high speed modulation of optical beams. In this regard, we say a ‘modulation means’ is a module which can supply fast current pulses to a laser structure in view of its capacitance, complex impedance, and other electrical properties. Thus these modulators are coupled to their optical beam sources electronically in systems using QCLs and direct modulation techniques.

It would be impossible or extremely difficult to modulate a gas laser by switching its excitation source. A gas laser calls for an alternative modulation scheme.

2) Solid State Modulator

Lasers of either type, gas or solid state, can be coupled to a special solid state modulator. Bulk crystal materials such as Galium-Arsenide or Cadmium-Telluride provide a basis upon which important electro-optic modulators can be configured.

A solid state modulator can be made using the ‘electro-optic’ effect. Bulk crystal materials presenting the electro-optic effect can be made to modulate either phase or polarization of a light beam. Cooperation with other elements, for example a polarizer or a second coherent beam, yields amplitude modulation.

Electro-optic modulators suitable for use in high bandwidth Mid-IR FSO systems are particular indeed. They must be exceptionally fast, have modest power consumption, and be operable at Mid-IR wavelengths. Thus, they have physical characteristics and configurations associated with them which are unique to Mid-IR FSO objectives. These are discussed in detail below.

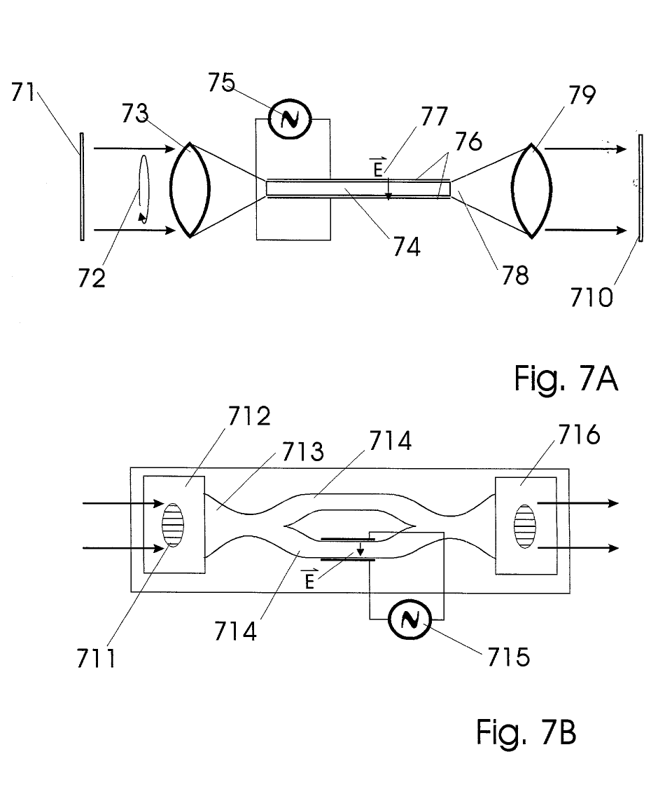

Preferred electro-optic crystal materials for Mid-IR wavelengths include CdTe, GaAs, ZnSe, and ZnS. Use of these materials as modulators is well known. However, the following two examples of modulator configuration include modulator systems of particular arrangement well suited for the application at hand, that is modulation of a Mid-IR optical beam at data rates greater than 0.1 Ghz having power consumption on the order of 10 watts. A first configuration is a bulk modulator FIG. 7A having modest bandwidth and the second is a waveguide modulator FIG. 7B having manufacture disadvantages but exceptional bandwidth.

A single crystal bulk modulator can be made to modulate a Mid-IR beam in a similar fashion to a traditional bulk modulator. However, as power efficiency and high bandwidth are important in FSO communications designs, it is advantageous to make the bulk modulator very small in size. This reduces the capacitance between electrodes and thus reduces both drive power and switching speed. With reference to the drawing figures, a quarter wave plate 71 changes a linearly polarized laser beam into a circularly polarized beam that enters lens 73 to become focused into the bulk crystal material 74. An oscillating signal 75 is applied to electrodes 76 to create electric field 77 particularly aligned to a crystal axis and thereby selectively changing the index of refraction. Application of an electric field tends to advance the phase of either of two orthogonal directions with respect to the others thereby changing circular polarized light to linearly polarized light in either of those two directions. Light exiting the crystal 78 will either be polarized parallel or perpendicular to the plane of the drawing page. That light is recollimated by lens 79. The light is then passed through an analyzing polarizer 710 to extinguish or pass the beam in agreement with the applied fields. In preferred versions, the cross section of the material is approximately 0.1 mm by 0.1 mm and between 10 to 50 mm in length.

In another embodiment which yields yet a higher bandwidth but additional complexity in operation and manufacture is a thin film waveguide Mach-Zehnder type interferometer having prism couplers on either end. This device is sometimes preferred because it yields a very high bandwidth compatible with FSO systems. Unfortunately, coupling optical beams into thin film waveguides present certain difficulties not easily overcome and a greater coupling loss is expected in comparison to bulk material type devices. Again referring to the drawing figures, a laser beam having any polarization 711 is coupled to a waveguide by way of a prism coupler 712, thereafter the light is forced through a horn 713 into two separate arms 714 of an interferometer. One arm consists of a crystal aligned whereby an applied field 715 introduces a polarization change in the light passing through that arm. On recombination in a second horn, the beams will interfere to produce an additive or subtractive superposition due to the change in phase of the beam in one arm. A modulated laser beam will exit the thin film at a similar prism coupler 716 and pass to the rest of the transmitter system.

3) GAS or Stark Modulator

Certain versions including gas lasers use a very different modulation strategy. By way of optical absorption, an optical beam can be alternately attenuated and passed in response to an applied electric field. For example, a Start effect gas cell may be used as a fast ‘shutter’ in an optical beam to attenuate the beam or pass the beam as alternating electric fields are applied to a gas contained in a cell. Details regarding such Stark modulators may be more fully appreciated in consideration of U.S. Pat. Nos. 4,291,950 and U.S. Pat. No. 4,656,439.

Or, more importantly, in a paper entitled: “Wideband modulation of the C¹³O₂¹⁶ laser R(18) line at 10.784 μm with an N¹⁴H₃ Stark Cell” which sets forth the basis for a fast modulator of compact size. Use of these types of modulators can yield benefits to combinations in support of FSO systems.

The above mentioned Stark cell modulators are of great importance for the immediate application because otherwise known Stark cell devices have two major problems not found in these special configurations. First, common Stark cells require a large voltage swing to create an electric field strong enough to bring about the Stark effect and shift the absorption line. While this is not an important factor in laboratories having sufficiently heavy equipment to handle high voltage change loads, it is quite difficult to run such Stark cells in a compact small office equipment in which a practical FSO communication system must fit. Both the physical size and electronic requirements of those common Stark cells will not permit their use as described here. Because the power, size and speed requirements of a commercial FSO communications link demands special properties, the combination of these special Stark cells with a special laser is preferred.

Certain benefits can be realized by placing a modulator inside a laser optical resonator cavity. Basic laser theory suggests a gain curve and loss line. Because the Stark effect is a weak effect, the cavity length will need to be very long to absorb the full laser energy. In contrast, where a stark cell in put into a cavity, the absorption only needs to be great enough to move the loss line up above the gain curve which may be quite easy in comparison with having a stark cell absorb the entire laser beam. Therefore, it is recognized that Stark cell modulators can be place both inside or outside a laser cavity to achieve the objective of modulating a beam of light.

Waveguide—Non-Waveguide Versions

In both solid state and gas cell modulators it is possible to configure them as waveguides or to leave the devices without lateral constraints. In one Stark cell version, a modulator is formed as an optical waveguide where a beam is coupled into a first aperture, propagates under waveguide principles through the device which contains a Stark gas and leaves an exit port. In this way, the beam is controlled and stays within a small volume giving the advantage that the electrodes have very low capacitance and thus reduced drive requirements for a particular bandwidth. Of course, it is not necessary that a Stark cell be constructed about a waveguide structure and Stark cells without waveguides are fully contemplated.

Similarly, in solid state devices a ‘bulk modulator’ assumes the size of the beam is small in comparison to the lateral extent of the crystal. However, this in not always the case. Indeed, a solid state device can be made where a beam coupled therewith goes into a waveguide mode due to the boundary conditions of the very narrow device. In this way, the electrodes can be made very near each other and improving the speed and power characteristics of the device.

Of special interest is the case where the device is very small but not yet a true waveguide. A partial waveguide device is possible where the aperture is a few times or up to about ten times the size of the wavelength of the light beam. A multimode coupling is assured by such arrangement. Spatial filtering on modulator exit can improve the beam quality.

It is important to recognize that FSO systems place a serious speed requirements on modulators and thus drives the need to configure them as described here. Modulators in common configurations will not support FSO objectives. The arrangements proposed here offer a good and novel way to have fast modulators which cooperate with high bandwidth systems.

### Receivers

Detectors

Although these Mid-IR FSO systems have wonderful characteristics with regard to transmission in unfavorable atmosphere, Mid-IR light is not easy to detect as detectors operable at these wavelengths are not very sensitive in comparison to detectors used with other spectra. This is just one of the ‘trade-off’s where Mid-IR based systems suffer. Careful selection and manipulation of components mitigates detector sensitivity issues.

HgCdTe solid state detectors are sensitive in the spectral regions of interest. Not only that, they are exceptionally fast due to a high speed recombination mechanism with respect to electrical carriers therein and so are nicely suited for high bandwidth applications like FSO communications systems. Although some versions of these inventions might be configured with HgCdTe detectors, it is not always considered a best mode as these devices are accompanied by some difficulties. Firstly, HgCdTe is not as stable and rugged as other materials. This material will melt easily when subjected to high temperatures. Also, as manufacture techniques are complex and raw materials are difficult to handle, these devices are quite expensive and not appropriate for mass production. Further, HgCdTe is not commercially available in large numbers. In special cases, HgCdTe makes a good detector for Mid-IR FSO systems, but other systems will benefit from a preferred type of photodetector.

In particular, a preferred detector is sometimes known as a quantum well infrared photodetector, or QWIP. QWIPs are solid state semiconductor devices. In particular, a crystal is grown from material such as GaAs and AlGaAs in alternating layers in a repetitive structure a bit like the QCL laser. The mechanical properties of the device form electron traps or ‘quantum wells’. Low energy photons passing in the crystal can be absorbed by trapped electrons giving them enough energy to become liberated from their quantum well and transit into a conduction band where they are drawn off as photocurrent.

QWIPs are most generally used in photodetector image arrays for advanced imaging systems. Although these devices are well developed, their use is generally for very different purpose than the use proposed here. QWIPs in service today enjoy the benefit of being operated in an extremely cooled state. Cryogenic cooling is available to most of these systems which are large scale laboratory experiments or are supported by heavy apparatus. Because cryogenic materials are hard to handle by non-experts and they take considerable care and attention, QWIP use is not considered appropriate in common consumer products and office equipment. QWIPs are not used in room temperature environments or similar conditions.

Because preferred versions of these inventions call for extremely fast photodetectors operable in an office environment or protected outdoor use, special combinations of electronic cooling systems and special types of QWIPs particularly responsive at elevated temperatures are combined to serve the Mid-IR FSO objectives. A QWIP may be operated in an ‘under-cooled’ condition where its detectivity is not optimal but sufficient. The cooling is obtained not by cryogenic materials but rather by electronic devices known as thermo-electric coolers or ‘TEC’s. Normal QWIPs are not effective in this configuration. It requires a highly doped QWIP to properly achieve detector responsivity at elevated temperatures generated by TECs. Although the term ‘elevated temperatures’ is used, the use is relative to normal QWIP operation. ‘elevated temperatures’ can mean about 200K or about −100° C. which in other circumstances might be considered very cold.

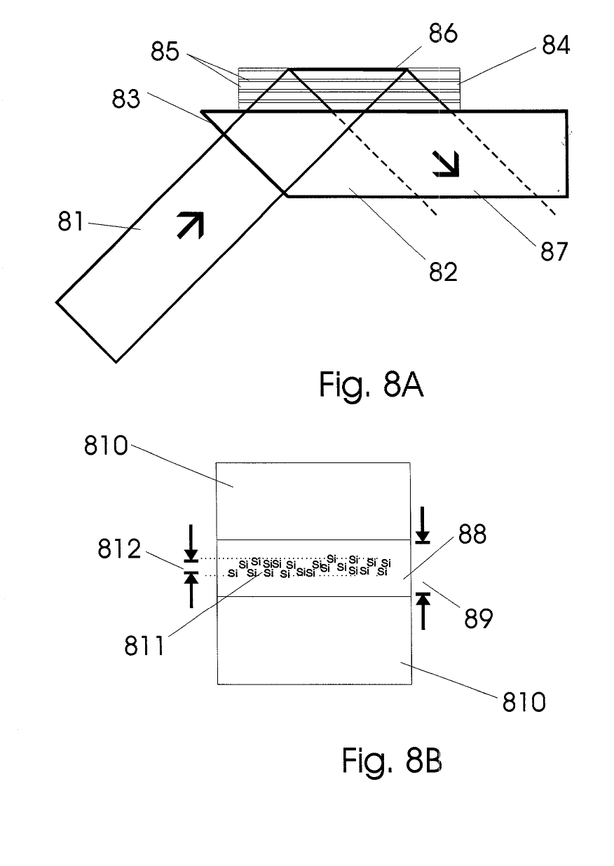

Therefore, in Mid-IR FSO communications systems a preferred detector includes a highly doped QWIP combined with a TEC cooler. A QWIP type detector usable in FSO communications applications is illustrated in FIG. 8A. An encoded optical beam is received and directed to a QWIP via special coupling. A slab material 82 forms a basis upon which a QWIP structure is grown. The slab includes a special coupling facet 83 whereby the light enters the substrate at normal incidence to reduce reflection losses. The beam propagates into the QWIP structure 84 made of alternating layers 85 of GaAs and AlGaAs. The beam reflects from the top surface in a total internal reflection and makes a second pass through the QWIP structure. Finally the remaining beam energy 87 exits the detector or is stopped at a beam dump.

Unlike QWIPs in the art, QWIPs of these inventions are specially designed with a high level of doping to support use at higher temperatures. The detectivity is improved in comparison to similar QWIPs without a high level of silicon doping. For a more complete understanding, consider FIG. 8B. Recall that a QWIP is formed of alternating layers of GaAs and AlGaAs 810. The GaAs layer 88 is made with a prescribed thickness indicated as 89 in the drawing. In the process of growing that layer, a silicon dopant 811 is sometimes introduced in the middle portion 812. When the dopant level is increased to about 1.5×10¹² atoms per square centimeter, it has been discovered that the detector will have improved response at high temperatures. For normal uses of QWIPs, this is not acceptable. The overall sensitivity is spoilt by the increase in dopant; this conclusion follows with the assumption the device is cryogenically cooled. Where the device is required to be operated at a high temperature, increased doping improves the device responsivity.

In the case where a QCL type optical beam source is used, the quantum wells of the QWIP are configured and designed in agreement with the quantum wells of the QCL to achieve special cooperation therebetween. Thus, a QWIP detector can be made with a view to a QCL source and be tuned to be highly responsive to the wavelength and linewidth of that QCL. Overall coupling between the source and detector is improved when these devices are tuned together.

In addition, both the QWIP and the QCL display a beam profile asymmetry. The QWIP is preferably arranged whereby a double pass improves the interaction length of the beam with respect to the wells. Thus, the beam cross section at any quantum well layer will be elliptical if the beam which enters the prism is circular. Since a QCL intrinsically produces a beam which is not circular but rather semi-elliptical, it is possible to further improve the interaction cross section of a beam from a QCL by aligning the asymmetries of these devices in a manner which increases the detector interaction area.

Now that the picture is clear as to the major components individually, it is useful to look at them closer ensemble. The following set of drawings and description is directed to preferred modes of arranging optics components to form a Mid-IR FSO optics head; i.e. the transceiver of a link node.

Optics Layout

Objectives of a Mid-IR FSO system are met via very special layouts of optical components. In particular, consideration is made for physical parameters of chosen air columns, i.e. length, cross section, particulate density, among others. Further, consideration is given to the design wavelength, for example materials having certain transmission properties are required. In addition, anticipation as to structural rigidity of systems deployed in an office or home environment requires special optical arrangements. Thus, sizes and configurations of optical components taught are very particular with respect to the FSO communications links proposed herein.

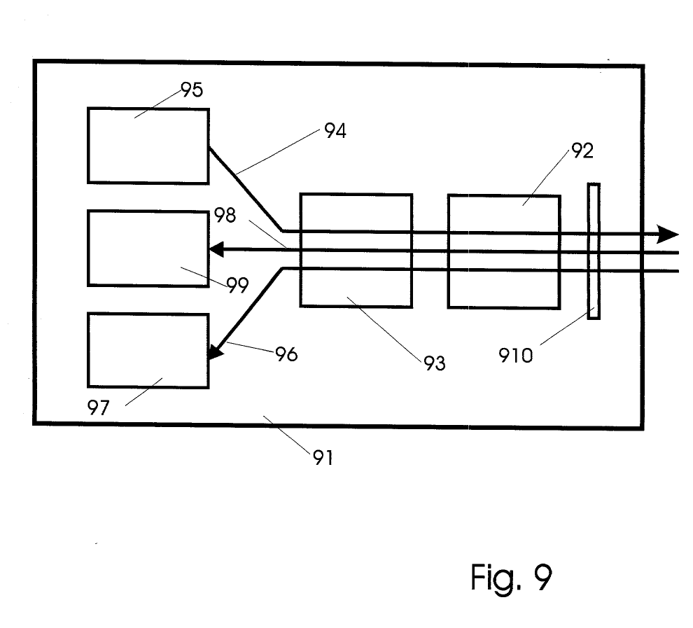

A primary feature of preferred optical layouts of these inventions include unique arrangements whereby three separate optical paths share certain components yet do not share others. For example, three separate optical beams can share a Mid-IR coupling window. In addition, three separate beams can share a single telescope. More importantly, three separate beams share a beam steering system. The notion of optical component sharing in this way is illustrated in the block diagram of FIG. 9. An optical head 91 contains optical components aligned and arranged to cooperate with the others. An optical window 910 allows all three optical beams to pass therethrough and to be coupled to an air column while at the same time protecting the interior of the optics head from contaminants. A single telescope 92 is simultaneously operable for three separate beams and condenses or expands these beams into beams in the normal operation of such telescopes. Another shared component is a steering system 93 which allows three optics subsystems to be coupled together to a constantly moving ‘target’; a distant transceiver. Thereafter the steering system, each of the three beams is split and handled independently of the other beams. Beam 94, is a transmitter 95 output beam for transmission of a modulated carrier signal. Beam 96 is an input beam which is passes to a detector and associated electronics where a sensitive fast detector 97 converts pulses of light into pulses of electricity. Beam 98 falls incident upon another specially arranged detector 99 to perform centroiding operations as feedback to a fast steering mirror described more fully below. It is important to note that although many optical systems having a plurality of optical paths share beam space, they generally do this with a common optic axis. In some versions of these inventions, this is neither necessary nor preferred. Indeed, preferred versions include arrangements where optic axes of these beams are sometimes parallel but not collinear. Thorough review of the next few drawings yield a more complete description of these arrangements. Together, these elements assembled as described form preferred versions of a Mid-IR FSO transceiver or ‘link node’.

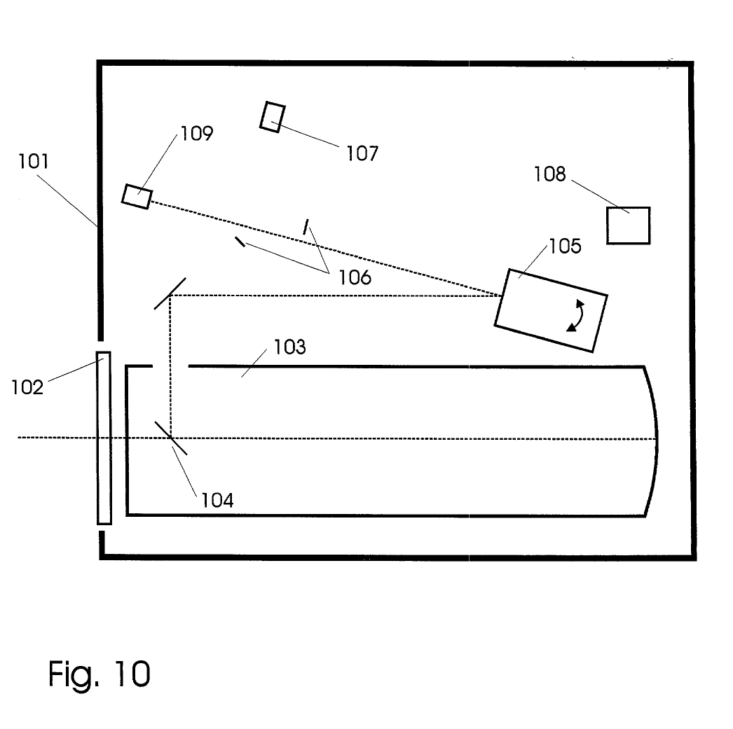

A more detailed description of the optics head is presented here with reference to the schematic drawing of FIG. 10. The optics head may include a housing 101 to isolate, mount and protect optical components therein. The housing comprises at least one port over which is placed a special window 102 compatible with transmission of infrared light of the design wavelength. More details of this window follow in later presented sections. Properly aligned and in close proximity to the window, the optics head includes a telescope 103 of the Cassegrain or similar configuration where a turning mirror 104 routes the beam towards additional optics components. A two axes, fast response steering mirror 105 operates to move the beam in order that alignment may be adjusted dynamically. Beam scrapper elements 106 couple portions of the telescope beam space to a steering feedback detection system 107 and from a laser/modulator combination 108. Energy in a telescope beam not incident on the scraper elements is passed to a very fast communications detector 109.

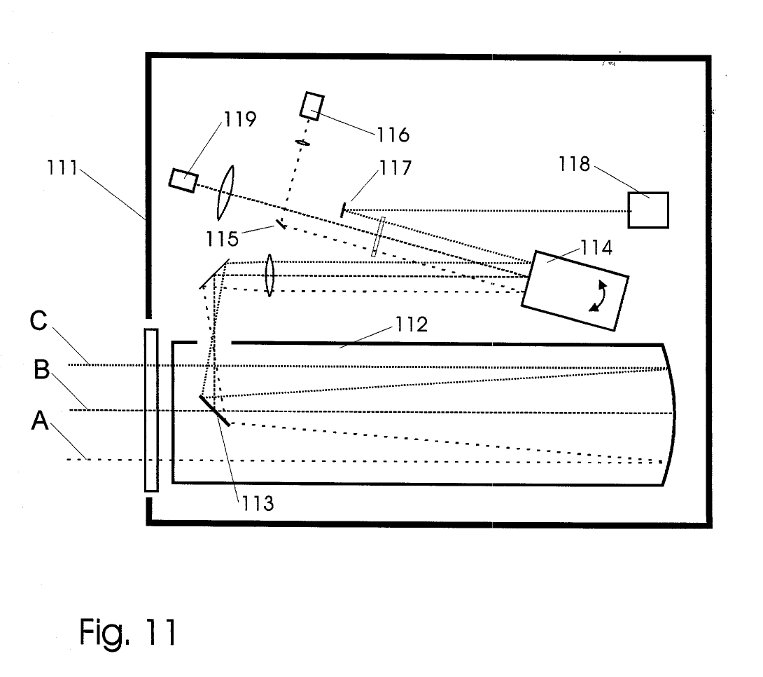

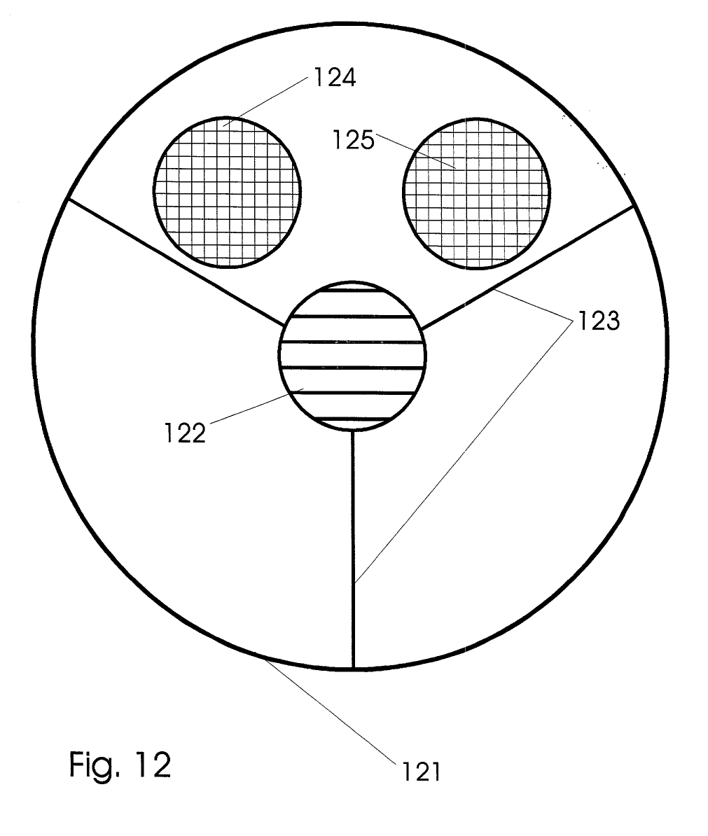

One will appreciate the beam scraper elements 106 are placed within the telescope beam space but are not on the telescope optic axis. This has important implications more easily understood in view of the next two drawings FIGS. 11 and 12. FIG. 11 shows an example optics set-up having three displaced optic axes A, B, and C. Optic axis ‘A’ traverses housing through Mid-IR window 111 and telescope 112 and goes from front side mirror 113 further into the optics train. A portion of fast steering mirror 114 thereafter bends the optic axis ‘A’ toward scraper mirror 115 and further to steering feedback detector 116. In a similar fashion, optic axis ‘B’ which lies on the telescope symmetry axis is folded at the steering mirror and lands on detector 119. Finally, the third optic axis, axis ‘C’ defines a path through the telescope, steering mirror, and scraper mirror 117 to terminate at a light source 118. Since the scraper mirrors 115 and 117 are off-axis with respect to the telescope axis, they effectively map to telescope beam space which is illustrated in FIG. 12.

FIG. 12 is a cross sectional drawing to depict telescope space allocations. Circle 121 defines a telescope circumference boundary. Circle 122 defines a region that is void due to the necessity of the telescope turning mirror. Radially extending support members which hold the turning mirror maps to the telescope space as lines 123. A first scraper mirror 115 can map to telescope space as circle 124 and similarly the second scraper mirror 117 maps to telescope space as circle 125. Thus it is clear how three separate optical trains can share the telescope space simultaneously.

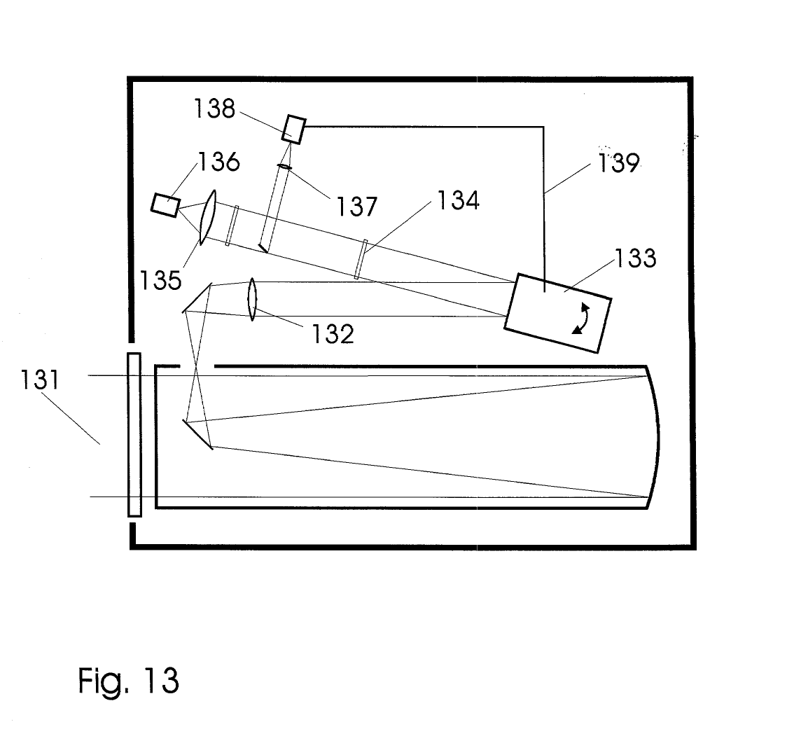

To more completely present the story, FIG. 13 includes a ray trace diagram illustrate the paths of the two optical beams of the detection systems. A received beam 131 enters the telescope through a special Mid-IR window and is recollimated by lens 132 to land on steering mirror 133. A bandpass or line filter 134 may be used to eliminate light in frequencies not generated at the optical beam source. A lens 135 condenses the beam onto a small, fast detector 136. A portion of the beam reflected from a scraper mirror is similarly condensed by lens 137 and is incident upon quad type detector 138 which is arranged to provide feedback 139 to the fast steering mirror.

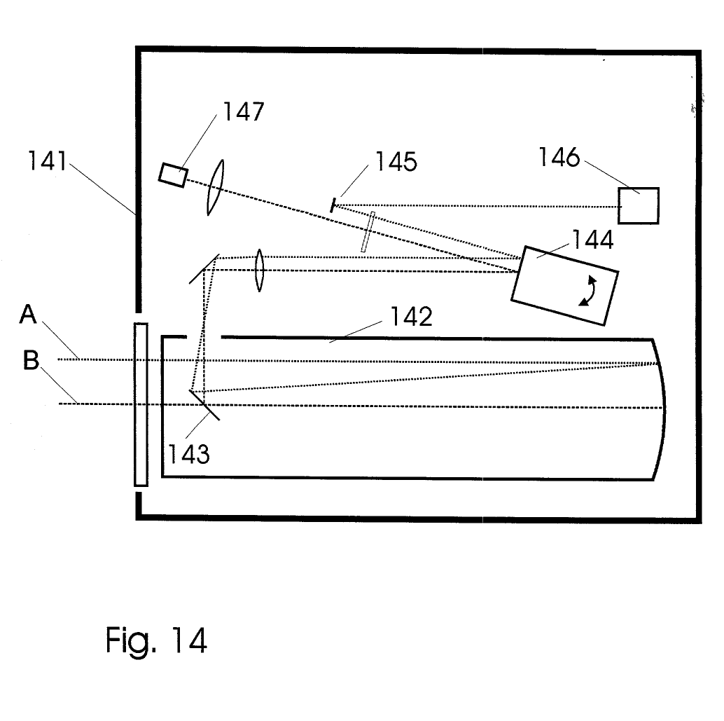

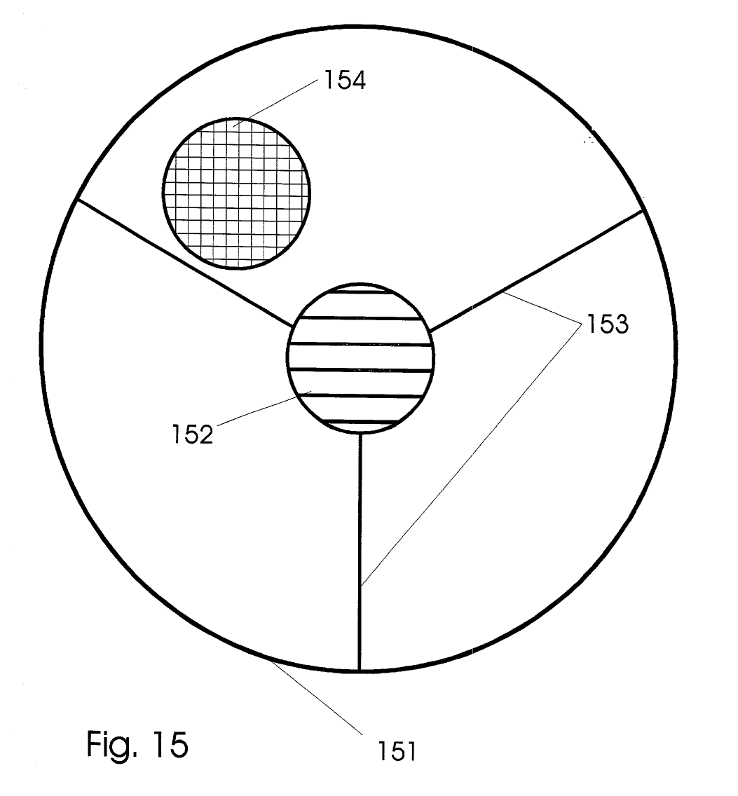

Some advanced preferred versions combine the two detection systems, i.e. the communications detector and the steering feedback detector into a single detector subsystem thereby eliminating the need to scrape off part of the beam. This improvement is made such that more of the received light ultimately ends up in the communications detector thus improving the link margin. FIG. 14 shows the alternative arrangement where there exists only two optical axes, a detector axis ‘A’ and a transmit beam axis ‘B’. Enclosure housing 141 protects optics including telescope 142, stationary turning mirror 143, and fast steering mirror 144. Careful review of the diagram indicates that optic axis ‘A’ is bent at scraper mirror 145 and traces to light source 146. The only remaining optic axis of consequence is optic axis ‘B’ which traces directly to a multi-function detector 147. A detector can be arranged to perform both the communications function and the steering feedback function. A quad detector arranged to perform summation on its received signals operates in the communications detector mode. When switched to a steering feedback mode, each of the quad cells is compared to the others to make a beam spot location determination as feedback to the steering mirror. The detector is switched periodically between the two detection modes. By reducing the optical trains from three to two, the detection scheme is made more efficient. This is readily apparent in consideration of FIG. 15 which shows telescope space allocations of a two train system. Telescope aperture is represented as circumference 151 having therein turning mirror shadow 152 and radial support lines 153. Only the space indicated as 154 is ‘lost’ to coupling the transmit system to the telescope and steering shared with receive functions.

Careful consideration raises an interesting point with regard to optical source asymmetries. Where an optical beam source has an intensity profile which is not symmetric, the asymmetries in the intensity profile can be well aligned with regard to asymmetries in any telescope space voids whereby beam energy is efficiently coupled to the telescope space. Where a centroiding scheme is used, a balancing ‘weight’ might be applied to either of the four detectors to bias the position of the beam in the telescope space.

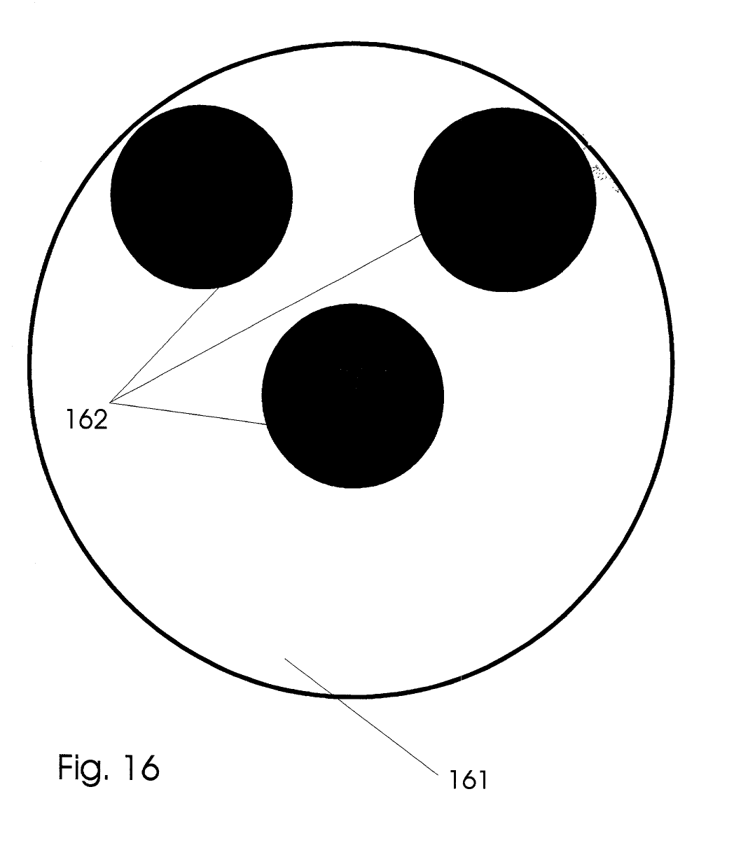

Since having an arrangement as proposed tends cause spurious reflections which may be undesirable, particularly from the optical transmit system which may have very high power densities, it is briefly proposed that carefully arranged spatial filters can eliminate those reflections. FIG. 16 illustrates a mask which may be inserted laterally in the optics path whereby pass region 161 allows light beams by and stop regions 162 block undesirable portions of optical energy. such a spatial filter may be placed just before the detection plane. Alternatively, polarization filtering can accomplish a similar function. Where beams are sharing space as described, these mechanisms may be used.

### Free Space Path—Air Column

It is important to understand that air column optical paths of these inventions can be considered structural components of apparatus. The air column is the transmission medium. Air columns of interest have length, volume, particular physical axis, certain compositions of matter, and cross section dimensions among others. In addition, some of these properties are dynamic and change with time; for example constituent gases, particulate matter, air currents, and temperature gradients. Just as a fiber is the transmission medium of a fiber optics system, the air column optical path is the transmission medium of FSO systems taught here. As the physical parameters of a fiber will effect systems performance, the physical parameters of air columns will effect the performance of systems presented here.

Further, many system elements are arranged with a view to couple optical beams into a particular air column or air columns having a particular set of characteristics. As such, the transmission media (air columns) of these inventions have characteristics which demand a unique combination of elements to enable communications therethrough. To properly and efficiently launch an optical beam into an air column, i.e. one which will cooperate with that air column, details of the particular air column must be considered. Thus, the Mid-IR FSO systems taught here include special cooperation between certain well defined transmission media which may be different than the media of other types of systems. Thus, careful readers will keep mindful that various air column optical paths and their parameters as well as the cooperation between other system elements and those air column optical paths are essential elements to some of these inventions.

Air columns of these inventions include those which are lowest in the Earth's atmosphere and thus necessarily have a comparatively high density of air and other matter therein. This high density air tends to support small particulate matter in a suspended state. Generally, particles having a size of the order of one micron or less can stay suspended in the air for long periods of time without falling to the ground. Water including vapor, fog and haze are generally of this type. Small dust particles are similarly troublesome and they may linger in an air column potentially causing difficulties to beam transmission. In addition to water and dust an air mass may include smog and natural gases for example carbon dioxide, hydrogen, nitrogen and argon among others. Thus air columns of concern here are partly characterized by their compositions. Transmission media of these inventions may comprise significant amounts or concentrations of foreign matter which tends to scatter, absorb or otherwise attenuate some optical beams passing therethrough.

The length of an air column necessarily has design implications on other system optical elements. For example, since the links of a Mid-IR FSO system which penetrates fog are substantially longer than the links of other FSO systems, the cross section of the beam is preferably wider at the nodes. This is to reduce losses to diffraction. Therefore a wide-aperture telescope design is preferred. Systems in the near IR have very short link lengths and enjoy the use of narrow width telescopes. Also, the final optic element which couples the beam to air columns of near-IR and Mid-IR systems, the window, are quit different. Since air columns of considerable length are proposed, steering systems must be designed with very high degree of pointing accuracy. Many additional system considerations presented in detail herefollowing suggest special consideration in view of the particular nature of air columns as defined herein.

Although some prior art systems have optical paths of many miles such as a deep space inter satellite communications system, and others may have short paths such as the very tightly knit mesh configuration of AirFiber, link distances of the present inventions are distinct from those others. These links are most generally between about 0.2 and 5 kilometers in length. Although under special circumstances, they may be increased or decreased, a preferred range is as stated.

Although most optical transmission media is not interruptible by foreign objects passing therethrough, a free space optical path of these systems is temporarily interruptible by objects such as airplanes, birds, insects, leaves, and kites among others. Because one cannot tightly control events which may interrupt the transmission medium, transceivers of these inventions include special adaptive mechanisms responsive to interruptions. Where a data stream is interrupted for a brief time such as in the case where a bird flies through a beam, an error is raised and a request for retransmission of interrupted data is conveyed. Thus a data stream previously transmitted but not properly received is re-transmitted so its arrival at the intended receiver is assured.

Other Elements

Gain Element/Telescope

The preferred antenna or gain element of a Mid-IR FSO transceiver is an all reflective type telescope. Near infrared systems generally use transmissive type telescopes with lens elements. These are not useful in best versions of systems presented here. This is due to the fact that lenses appropriate for longer wavelengths are extremely expensive especially when they must be made with large area apertures. Accordingly, Mid-IR FSO systems stand further in contrast from other FSO systems as a proper gain element includes a telescope of front surface mirrors. These telescopes may be arranged to provide a condensed and collimated beam directly to a steering mirror. Thus, it is said herein that the telescope is coupled to the steering mirror.

Steering

Some telecommunications transceivers, for example radio frequency systems, have properties which allow them to be set and left without active spatial adjustments between transceivers to keep them coupled together. Optical systems on the other hand sometimes require precise alignment adjustments. These alignment adjustments may include alignments which are dynamic and changing continuously. In such cases, a real-time steering system is devised to adjust the pointing direction of the beam into the air column and thereafter to a receiving transceiver. Still further, Mid-IR FSO systems in particular have additional parameters which demand special arrangements and consideration with regard to steering systems and coupling objectives.

FSO transceivers installed on a building ‘rooftop’ might include these beam steering devices. Beam steering devices compensate for movement of transceiver units. While tall office buildings may seem firmly in place, they actually display considerable sway to and fro, and twist and turn with changes in wind or earth motion. Therefore a Mid-IR FSO transceiver ‘rooftop’ unit may be subject to continuous changes in position and pointing direction. In addition, air currents sometimes operate as dynamic prisms which make the ‘apparent’ location of a beam's origin change in time. These movements and changes may need to be compensated in best systems which provide for greatest optical coupling of FSO transceivers to free space air columns.

For these Mid-IR FSO systems, special steering apparatus are arranged and used in a manner which cooperates with the wavelengths used. Further, particulars of anticipated air columns and link distances are considered. In addition, dimensions of system optics as well as detector sizes and coupling configurations are accounted for in the steering systems designs. Thus the steering systems and strategies for Mid-IR FSO systems are quite unique compared to common optical steering systems used in other applications.

Of particular importance, one should consider the implicit nature of steering arrangements for these Mid-IR FSO systems. Such implicit steering system has feedback confined within a single transceiver. Feedback across the link is not direct but rather is implicit only. Because the optical input and output of a transceiver are coupled together by way of a common steering mirror, steering corrections in the receive optical train translate automatically to steering corrections in the transmit optical train. In this way, when a received beam misalignment is corrected, the transmit beam is re-directed and the transmitter pointing is similarly corrected without feedback having been sent across the link. Thus, it can be said that the steering means operates to align optical trains in an optics head with respect to optical trains of other transceivers. In example, a local receive optical train is aligned with respect to a transmit optical train of a remote transceiver, and a local transmit optical train is aligned with respect to a remote receive optical train.

To effect a first version of steering, a receive beam is detected at a quad type photodetector. A centroiding operation is made with regard to the four detector elements to arrive at a pointing error signal. The pointing error signal is sent to a motion transducer affixed to a movable steering mirror. The mirror is moved to improve the centroid balance. Direct feedback between the quad detector and the steering mirror completes the feedback loop without regard for sending an error signal across the link to the transmitting station. On the other end, a similar steering mechanism is used. By applying alignment corrections to the receive optical train in either transceiver, corrections are automatically applied to the transmit train as they share the steering mirror.

Preferred versions of Mid-IR FSO systems have beam profiles which are quite different than those beams of near-IR systems. Accordingly, steering systems taught here account for those complex beam profiles. Optical beam sources of the QCL type tend to have a beam profile which is not symmetric. Unlike the cylindrically symmetric Gaussian beam of a well known gas laser, the QCL produces a highly asymmetrical beam having roughly elliptical cross section where the minor axis can be one sixth the major.

Even diode type semiconductor lasers do not display asymmetries similar to those of the QCL. To provide correction, the quad detectors are arranged to provide feedback signals weighted in a manner to account for the special beam profile of a QCL. As near infrared systems tend to have shorter links, their steering systems are arranged to cooperate with those short link distances. They do not have the angular precision required in air columns of considerable link distance. In the same regard, the detectors of common FSO links are quite large thus reducing the demands on the steering mechanism. In contrast, some preferred versions of these Mid-IR FSO systems have very small detectors. They are small in support of very high bandwidths; i.e. small detectors have small capacitance and fast response. Therefore, to keep a beam sufficiently coupled to a very small detector, the steering systems of these inventions have exceptional quality with regard to pointing accuracy and angular resolution.

In advanced versions of these devices, a steering system also include a scan-to-acquire functionality and mode. Where a system suffers a complete loss of signal, the steering system can be switched to a scan-to-acquire mode. The scan-to-acquire mode is a preprogrammed sequence of beam scans which enable a first transceiver to re-acquire a lost signal from a second transceiver. In one such scheme, a scan pattern is generated by a first transceiver while the second maintains steady pointing. If the beam is not re-acquired before the end of the scan pattern, the second executes a step function and again maintains steady pointing while the first repeats the scan pattern. At some point in the process, the beams realign and enable a steering lock. The steering system is then switched back to normal and continuous operation.

Input/Output

Transceivers of these inventions include support for input and output in electronic form. A transceiver receives an electronic signal as input and converts that signal to optical pulses as an output in the transmitter portion of the apparatus. In addition, transceivers include a receive portion which receive optical signals comprising modulated beams of light and convert those beams into electronic pulses delivered as transceiver outputs. These inputs and outputs may include standard type electronic components, connectors and data protocol arranged to cooperate with external data handling equipment such as which may be found in common communications networks.

Input facilities might include means for receiving digital electronic signals and coupling those to said modulation means. Thus input facilities may include electronic amplifiers to form a powerful signal used to drive a modulator. Output facilities might include means for conditioning a detector signal. Further, an output facility may include electronics components used to present signals as digital electronic bitstreams in a standard protocol. Output facilities may also include error checking schemes.

### Special Topics:

Asymmetric Links

Although links of preferred versions are symmetric in the sense that transceivers of two nodes have similar or identical arrangements of hardware, alternative versions may adopt configurations allowing reduction of complexity and expense. In contrast to systems versions detailed previously, asymmetric link systems permit novel arrangements whereby two link nodes in communication with each other are of very different configuration but complementary in nature. Namely, only one side of a link contains a light source (laser) which is shared with a cooperating node by way of a retroreflector/modulator arrangement.

In a first conveyance direction, information is encoded on a laser beam carrier via a first modulator which is local with respect to the laser. That beam propagates to a receiver where information may be decoded from the optical beam at a detector. To convey information in the other direction, the laser beam is generated at the first transceiver and passed without modulation, or continuous wave, to the second transceiver. In the second transceiver, a modulator receives the continuous wave beam and encodes it with digital information. In conjunction therewith, the encoded beam is passed to a retroreflector which causes it to propagate back to from where it came. At the first transceiver, the beam is decoded to retrieve the information from the second transceiver. In this way, it is not necessary to provide both transceivers with an expensive laser component. As such, maintenance and lifetime problems associated with lasers are reduced by a factor of two.

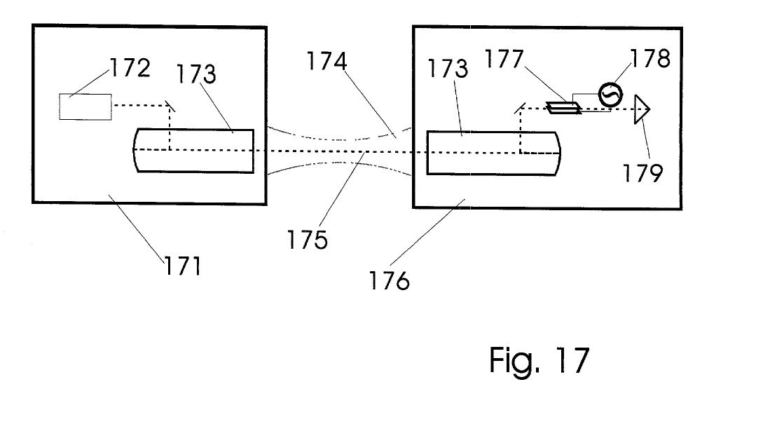

With regard to the drawing figures, a block diagram of FIG. 17 is presented to more thoroughly disclose these configurations. A first link node comprises a transceiver unit 171 having therein a light source 172 and telescope 173 coupled to air column 174 along optic axis 175. Optic axis 175 is further aligned and coupled to a second transceiver 176 which has a similar telescope 173. A special electro-optic modulator 177 may be driven by electrical signals 178 to alternately extinguish and pass the laser beam thereby causing pulses of light or a modulated beam. Retroreflector 179 turns a beam back upon itself and causes it to propagate in the opposite direction. Thus, a modulated beam returns to the first transceiver with information encoded thereon from the second transceiver. In this way, a bi-directional communications link is created where the system transceivers are asymmetric.

It is interesting to note that an entire link is made with only a single laser. In this configuration, information conveyance is bi-directional, but system complexity and expense are reduced. These arrangements are particularly interesting where weight and power consumption requirements are more strict at one node than another. For example, where a central computing station is amply supported by power and heavy hardware, it may be in communication with a great plurality of home or office units, or with highly mobile units such as soldiers on a battlefield.

Relay/Amplifier

In fiber optic communications systems which are quite common, a link between two nodes is sometimes supported by an amplifier situated between the nodes. This is due to the problem that both attenuation and pulse spreading effects tend to degrade a signal before it arrives at a detection node. Where the distance between two nodes is great, an amplifier stage may be used to recondition a signal midstream so that it may arrive at the detection node in good shape. Fiber optic communication systems sometimes handle this task with erbium doped fiber amplifier EDFA devices. Free space optics communication systems cannot support such configurations; but rather new and cleaver arrangements are used to support extra long links between communications nodes.

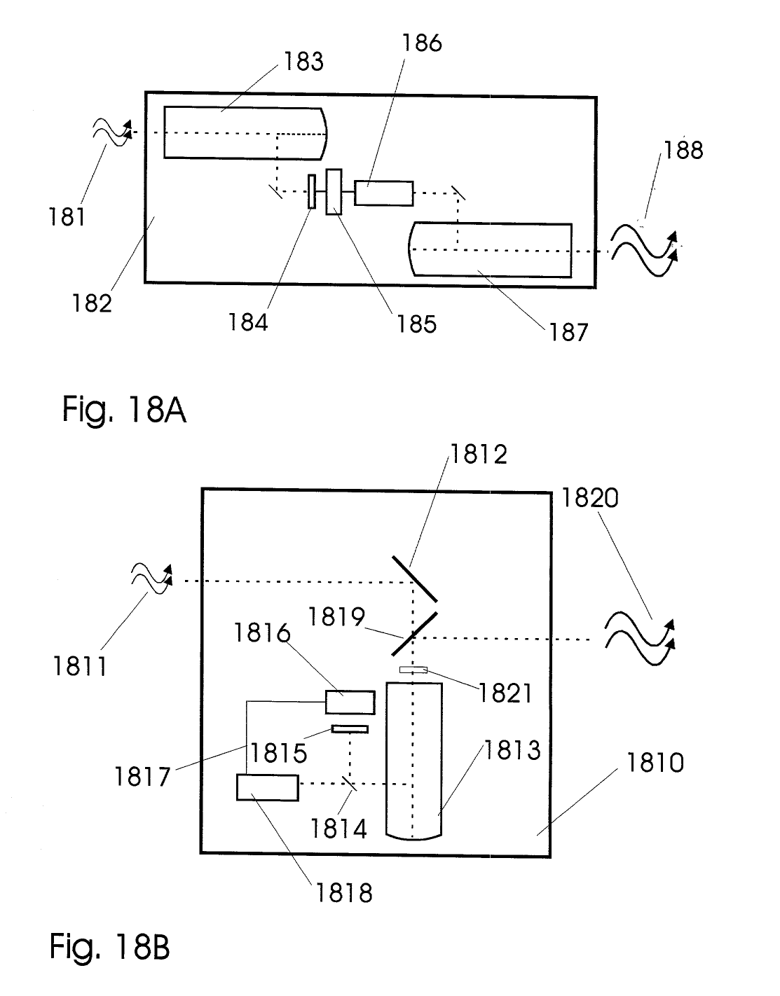

In Mid-IR FSO systems, an amplifier stage can be arranged to strengthen and recondition a digital signal as follows. With reference to drawing FIG. 18A, a weak signal 181 can be received at a specially devised amplifier stage 182 coupled with an air column by way of a telescope 183 which may include a beam steering system apparatus. A detector 184 positioned to receive optical energy from the input telescope collects an incoming optical signal and converts it to electronic pulses. Those electronic pulses can be conditioned and improved via signal processing electronics 185. A conditioned signal is thereafter fed to a laser/modulation means 186 which produces a strong and renewed optical signal containing the original information of the incoming signal. The renewed optical signal is passed to an output steering/telescope system 187 which couples the improved beam 188 back into another air column.

An output steering system and an input steering system may share some components; for example a telescope and fast steering mirror. This can be seen more clearly in the FIG. 18B where a weak beam 1811 in need of amplification and processing is incident upon mirror 1812 which deflects the beam into telescope 1813 and further to polarization beamsplitter 1814 which may operate as a steering mirror in some versions. By careful arrangement of input and output polarizations, losses at the beamsplitter are reduced. Detector 1815 converts photon input to electron pulses and is in communication with amplification and signal processing electronics 1816 which is further in communication via electronic path 1817 with a laser driver and laser 1818. Said laser produces a strong signal at a predetermined polarization and returns it through the telescope 1813 to mirror/polarization beamsplitter 1819 where it is routed onward as an amplified signal 1820.

One should appreciate the difference between a proper ‘node’ and a simple amplification stage. The amplification modules of FIGS. 18A and 18B do not require hard physical connection to a high bandwith source such as fiber ring. Further, they do not require a smart terminal such as a computer station. They can be ‘stand alone’ systems having common electrical inputs. However, they can effectively double a Mid-IR FSO link distance between two nodes.

For systems where a higher level of steering independence is required, 1812 and 18118 can be made fast steering mirrors which move independently of each other. In this way, the amplifier remains coupled to nodes on either side without the complexity of realigning whenever the communication direction changes.

Discontinuous Paths

While links in agreement with the already presented material normally have two transceiver stations and a continuous and linear optical path therebetween, some versions will benefit from a ‘folded’ or discontinuous optical path. In dense cityscapes where buildings lie near a large plurality of other buildings it is possible that no straight-line path will exist between two important locations where it is desirable to have transceiver stations, or nodes. In such cases, a path folding or ‘relay’ mirror can provide relief. Relay stations having mirrors, gratings, et cetera, protected within enclosures which accommodate optical beams of the size and wavelengths appropriate for 0.2-5 kilometer Mid-IR FSO links can be employed to cooperate with discontinuous optical paths. Thus some ‘air columns’ of these inventions are better characterized as being composed of a plurality of linear elements with discontinuities therebetween. Thus, transceiving stations may be coupled to one another via air column optical paths which are ‘folded’ or include a ‘kinks’. In this way, it is easy to account for situations of two nodes lacking a straight line clear path between them.

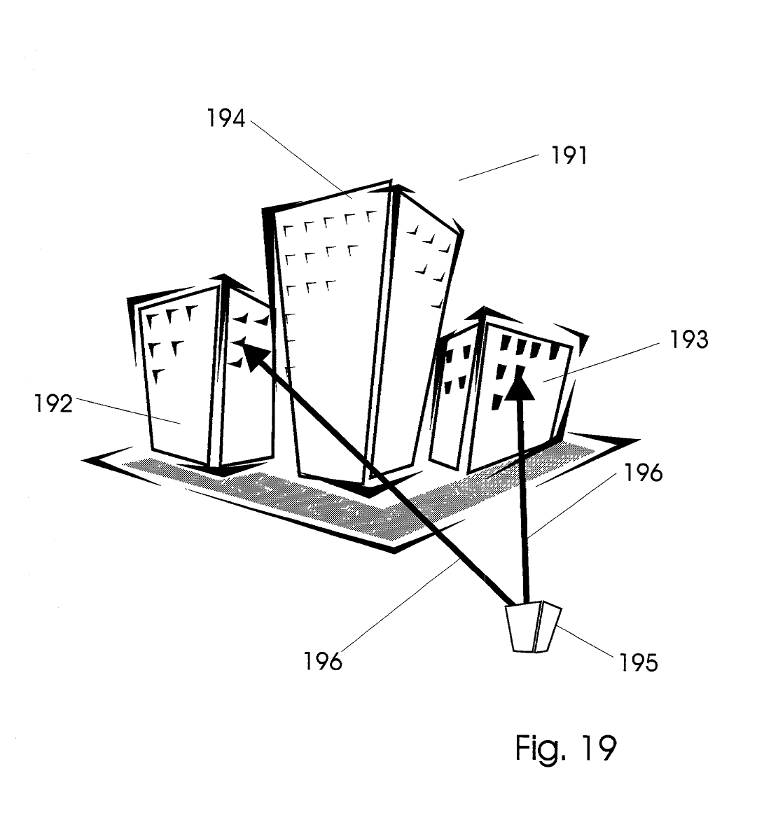

A more complete understanding is attained in consideration of the drawing FIG. 19. A large city 191 may be comprised of many buildings in a single city block. Need for a communications link may arise between two buildings; building 192 and building 193 nearby but not within direct line-of-sight. In this case, an optical relay 195 including a folded-beam path 196 feature my be employed to connect the two buildings. Light from either of two nodes follows a linear path to the relay where the propagation direction is changed and continues to the other node. In this way, Mid-IR FSO communications links having air columns formed of a plurality of linear elements between any two nodes are fully anticipated. The mechanism by which a beam is folded can be related to mirrors, gratings, holograms, phase kinoform structures, a-o modulators, among others. As the manner in which those devices can be used to fold a beam are well known, it is not important to elaborate further here.

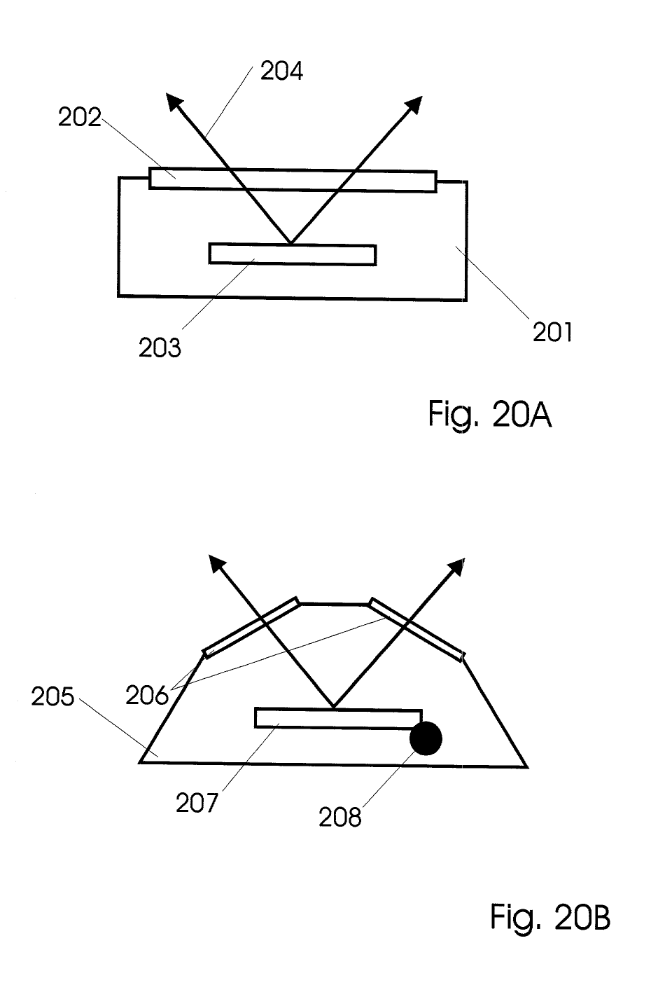

FIG. 20A shows that a beam folding device can also be housed in an enclosure having a window 202 to protect the optical element 203. The folded beam path is represented by ray 204. FIG. 20B suggests some configurations exist where and enclosure 205 comprises a plurality of windows 206 and where beam folding element 207 is actively driven by steering transducer 208 to dynamically align the path with transceiving stations.

Temperature Regulation

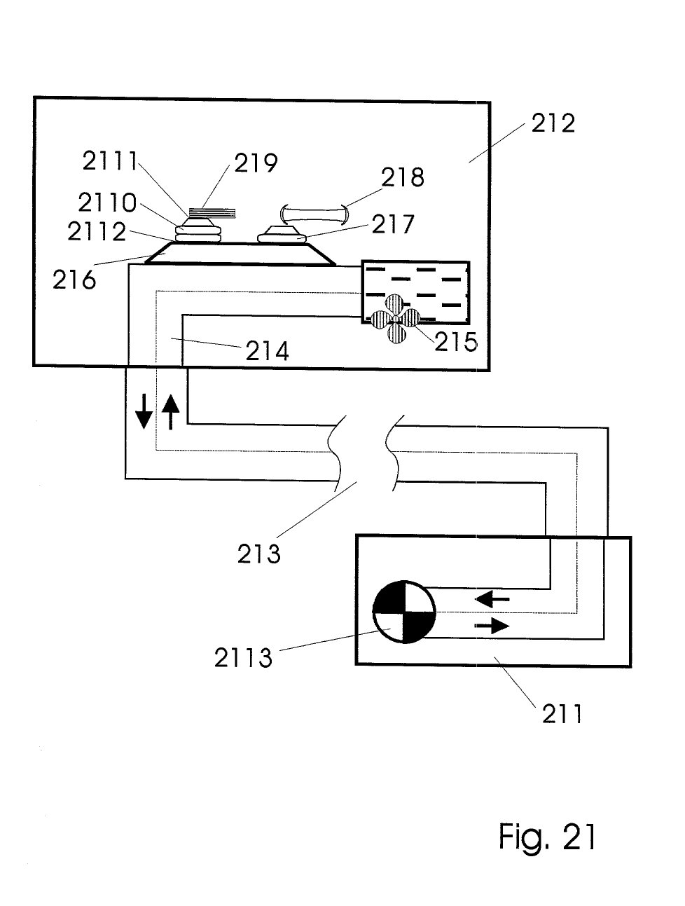

Some versions of FSO communications links taught here require particular cooling strategy. It is not enough to merely circulate air through an optics head to remove excess heat, but rather, some elements demand tightly controlled thermal conditions. A complex combination of cooling systems operate together to address the thermal loads of a plurality of devices simultaneously. These devices not only have very different heat generation capacity but also heat level or temperature requirements. For example, although a QWIP detector is preferably operated in a very cool state, it does not have a high thermal load. Contrarily, a QCL laser can operate at a higher temperature than a QWIP detector, but it has a very large thermal load as it has a high threshold current associated therewith. Finally, the environment of the entire optics head is preferable temperature controlled. These requirements thus result in a well balanced thermal management package which may be better understood in view of FIG. 21 and the following description. FIG. 21 shows a refrigerator 211 which is physically removed and separate from the optics head 212. A flex hose or other vibrational damping means 213 keeps vibrations generated in the refrigerator and from flowing liquids away from the optics head. A super-cooled refrigerant 214 passes through a heat sink 215 or optics head heat sink which may include an air circulation provision. This heat sink provides thermal control of the interior of the optics head; i.e. to all optical elements in the optics head. In preferred versions, the temperature of the optics head is best kept stable and cool. In addition to the heat exchanger 215, the super-cooled liquid from the refrigerator is also thermally coupled to a thermal pad 216. The thermal pad operates to provide a thermal circuit which efficiently draws heat away from heat sources. A thermal electric cooler TEC device 217 serves as a laser heat sink. It is an electronic device which operates to provide controlled, stable and cool temperature to devices connected thereto. For example, a quantum cascade laser is preferably operated in a cooled state. Thus, laser 218 which is in close proximity and is thermally coupled to the TEC can stay cool despite the fact that large amounts of currents are exciting the device. Similarly, QWIP type detector 219 demands a very cool operating temperature for good performance. Thus, a two-stage TEC 2110 can be used to further drop the temperature of the QWIP and serves as a detector heat sink. The TEC has a ‘cool’ side 2111 and a ‘hot’ side 2112. One can appreciate that a TEC 2110 as shown with its hot side joined closely to the thermal pad can be used to promote temperature control at the sensitive QWIP detector.

Point-to-Multipoint Links

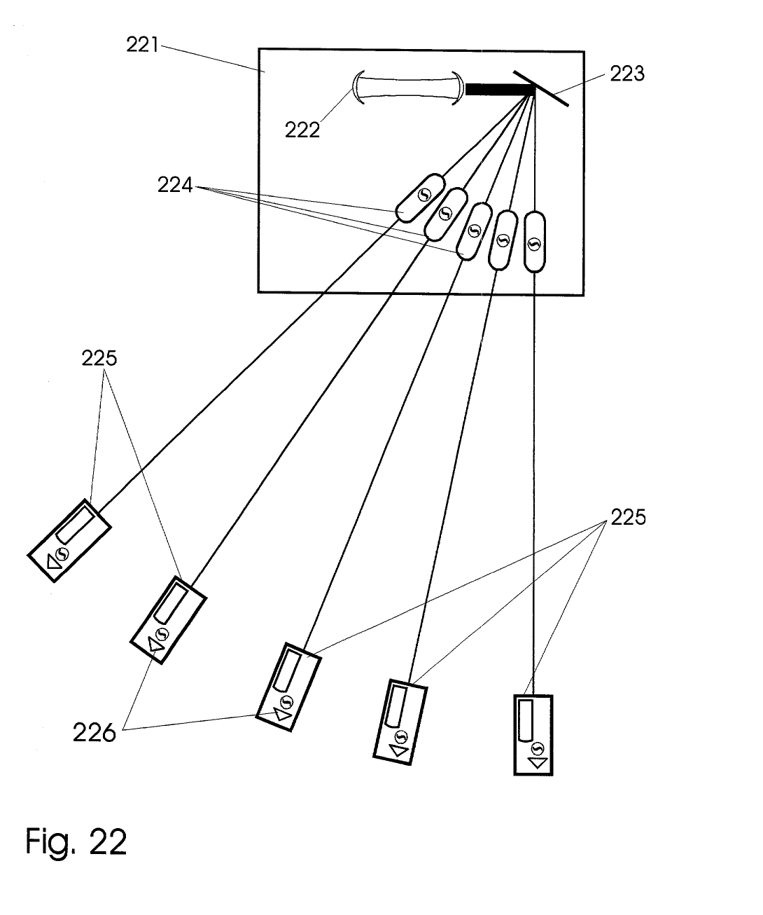

As mentioned in the optical beam source section previous, a point-to-multipoint arrangement may be supported by certain versions of these inventions. This may be particularly attractive where a retroreflector/modulator is used on the receiver or ‘multi-point’ side of the arrangement. One laser can be used to serve up to 30 or more independent and separate links. The multi-point side of any link would be very inexpensive as it would consist of minimal hardware quite durable in nature; i.e. no lifetime problems. Drawing FIG. 22 illustrates a configuration of a point-to-multipoint system. An special version of an optics head 221 contains a very powerful gas CO₂ laser 222 whose beam is split into a plurality of equal beams spatially separated at a beam divider 223 such as a holographic optic element. Separate modulators 224 independently modulate a branch of the laser beam. The beam is thereafter passed through multiple separate air columns to arrive at various receivers 225 spatially separated from each other. Those receivers are compact, brief, and inexpensive as they may be without a laser and supporting hardware. These multipoint receivers may be equipped with retroreflector type modulators 226. In this way, these inventions filly include and contemplate point-to-multipoint type system arrangements.

Wavelength Division Multiplexing

The bandwidth of a communications system is an important measure of performance. Fiber optics networks have achieved remarkable bandwidths partly due to a scheme called dense wavelength division multiplexing, DWDM. Signals encoded on different color carriers propagate together down a single fiber. On either end, the colors are separated and coupled to appropriate channels of parallel electronics. In free space optics systems, it is possible to use a similar dense wavelength division multiplexing scheme.

Wavelength division multiplexing cooperates especially well with certain versions of FSO systems first taught here. In particular, systems employing QCL type light sources have a great advantage. When forming a multi-wavelength configuration, QCLs afford great control with respect to their spectral properties. Not only can they be designed to a precise wavelength, the linewidth can also be manipulated in the device design. In this way, QCLs particularly support use in multi-wavelength systems. This advantage cannot be found in common semiconductor diode lasers.

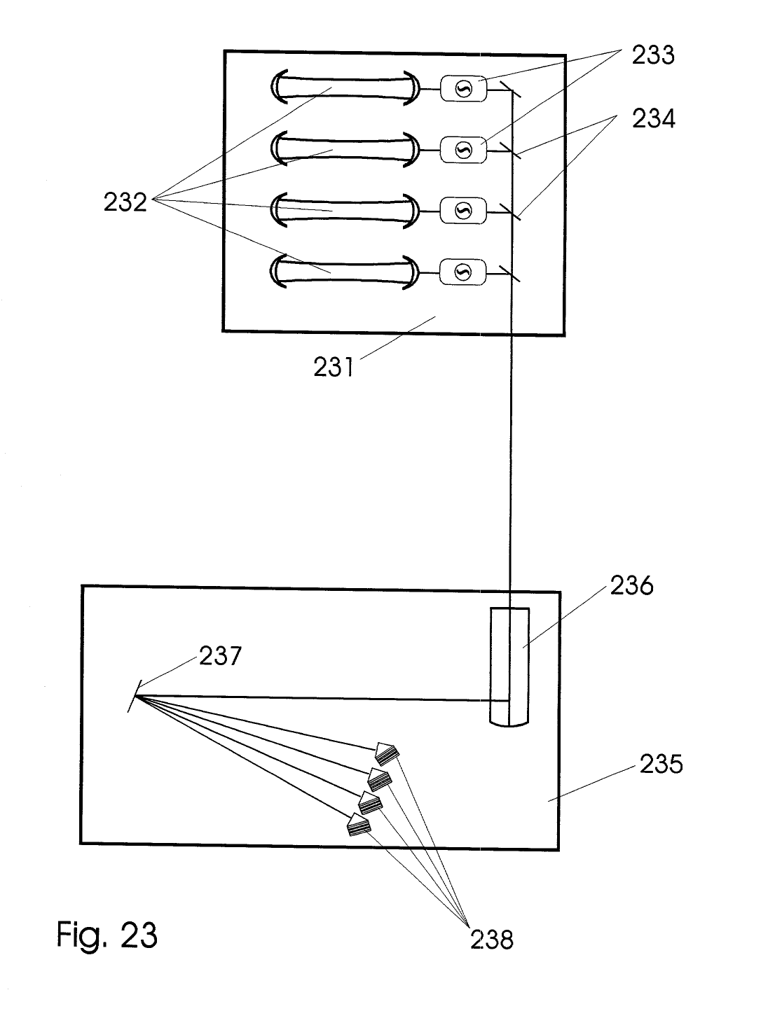

FIG. 23 illustrates the possibility of including a scheme of wavelength division multiplexing to greatly increase system bandwidth without appreciably increasing hardware requirements. A transmitter 231 portion of a node can include a plurality of lasers 232 each of which lases at a different wavelength. Each of the lasers is in communication with a modulation means 233. The independent beams can be made coaxial by properly aligned beam combining elements 234. The multi-color beam can then be passed through an air column to a specially arranged receiver 235 having telescope 236 and chromatic separating element 237. The beams are separated spatially and independently detected at detectors 238. A system bandwidth is improved by a factor equal to the number of colors transmitted as each colored beam carries the same bandwidth of a single color system.

Space Division Multiplexing

In fiber optic communications systems, the fiber is a waveguide which effectively scrambles any spatial information. Signals coming out the end of a fiber are not spatially separate but emanate together from a single ‘point’. FSO systems do not have this attribute. Indeed, spatial properties of carrier signals may be preserved in a FSO communications link. This fact lends to a multiplexing scheme herein known as space division multiplexing which may be used to greatly increase the bandwidth of an FSO links of these inventions.

For clarity, the following examples are drawn to spatial multiplexing in a single dimension without loss of generality. Extension to a second spatial dimension follows directly.

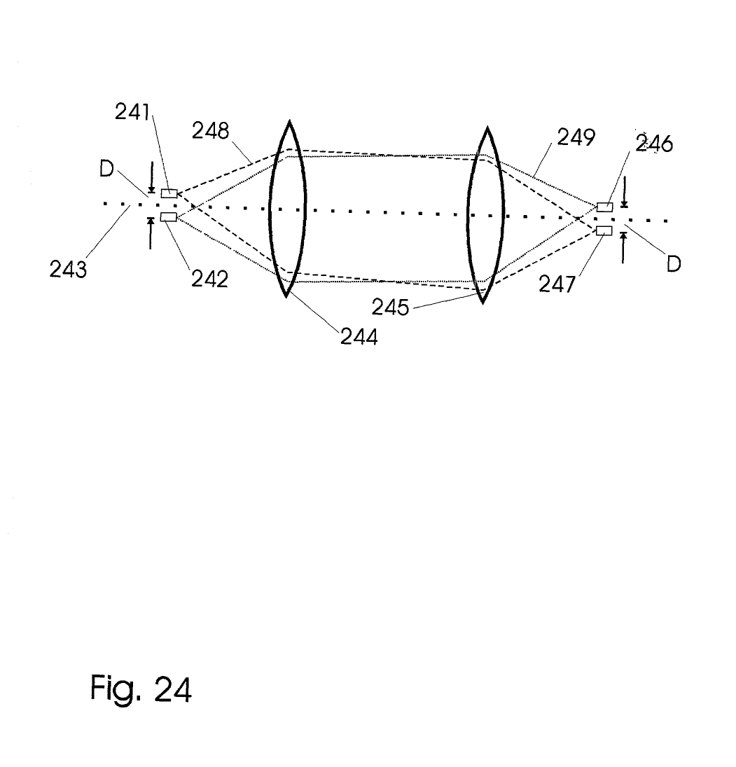

In FSO communications systems where spatial division multiplexing is used, a plurality of sources are displaced in position with respect to each other. The sources operate independently as separate channels and may carry different information without regard for the information carried by the other. However, they may share some optical systems such as beam shaping optics, telescopes, steering systems, air columns, among others. In a detection plane, the signals are separated spatially and resolved onto separate detectors. The drawings include FIG. 24 whereby this concept is more thoroughly explained. FIG. 24 shows two lasers, a transmit telescope, a receive telescope, and two detectors in a simple ray diagram presentation. Specifically, a first laser 241, and a second laser 242, are slightly displaced from an optic axis 243 by a distance ‘D’/2. Transmit telescope 244 collimates both beams and passes them to receive telescope 245 where the beam is collected and focused onto detectors 246 and 247. The detectors are similarly displaced from the optic axis. In consideration of the ray traces 248 and 249, one can verify that signals broadcast from a first laser land solely on a first detector and signals broadcast at a second laser land solely on the second detector. In this way, a single optics head and air column may be multiplexed to carrier a plurality of signal beams simultaneously. It is not a difficult step to extend this scheme to an 8×8 array whereby each channel operates independent of the others. The bandwidth could then be 64 times the single channel system.

It is further possible to combine wavelength division multiplexing with spatial division multiplexing. Each of 64 spatially removed channels comprising a plurality of signals of different wavelengths. On the receive end, the spatial channels are resolved first and thereafter the spectral channels can be resolved with a prism or prism equivalent device. Where there are ten colors on each spatial channel, the bandwidth is 640 times the single channel system.

Mid-IR Windows

Like most optical systems, Mid-IR FSO communications systems taught here include optical elements having surfaces vulnerable to damage or contamination by dirt and other matter floating in air. Lenses and mirrors have surfaces which must be protected from dirty air environments. Some optical systems have optical components protected in a sealed containment chamber having a window. Air is prevented from circulating into the chamber and the window passes optical beams to and from the chamber interior. However, simple glass windows are not available for Mid-IR optical systems because glass is opaque at Mid-IR wavelengths. Some applications have used inexpensive windows which pass Mid-IR light, for example a window made of a salt material transmits Mid-IR light and prevents air from entering an enclosure. Welding apparatus have included these types of Mid-IR windows in their systems. However, these types of windows are not acceptable for Mid-IR FSO as they are not durable. In the case of a salt window, damage is nearly immediate as moisture in the air degrades the crystal from which these windows are comprised. A salt window has a very limited lifetime and soon dissolves away when exposed to an atmosphere containing water.

To provide a barrier between sensitive Mid-IR FSO systems optics and elements from which an air column is comprised, two choices including thin films and special materials are detailed as follows.

Thin Films

It has been discovered that certain inexpensive materials can pass Mid-IR radiation if it is arranged in a particular fashion and within strict design parameters. The design structure permits tolerable absorption losses and reduced interference from backscatter and reflections. It is can be made to support large aperture designs found in some versions of these devices with regular thickness over that aperture. It is inexpensive and has high workability. It has long lifetime; but is easily and inexpensively replaced at the end of its useful life.

Like the ubiquitous thin film plastics found in various applications from food wrap to protective coatings for delicate surfaces, thin film plastics technology may be employed to form thin plastic windows suitable for use in Mid-IR FSO systems. Materials used in thin film technologies may not actually be ‘transparent’ to Mid-IR light, but made thin enough, they will pass a beam with limited attenuation. Thus, a carefully prepared thin film element may serve as a Mid-IR window in optic heads of some versions of these inventions.

Thick Windows of Special Materials

In some cases, thick windows of special materials may be used. ZnSe, Ge, CdTe flat optical elements are made with sufficiently large aperture to be used as a window to the optics head. These materials transmit light in the Mid-IR spectral region quite well. A major problem with these materials is their expense and workability. As devices of the present inventions designed for mass production are subject to manufacturing cost limits, it is an important consideration to not include large area pieces made from such expensive material. For example, ZeSe elements tend to be expensive thus use of ZeSe may be cost prohibitive in economically sensible arrangements. Accordingly alternatives may be desired.

Coupling to Interior of Building

As Mid-IR FSO systems are developed to deliver high data rate communications their deployment not surprisingly will primarily be where consumers data are located, i.e. in office buildings and homes. This gives rise to a rather unique problem not found in similar near IR FSO systems. In near IR FSO systems, an optics head can be placed in a building's interior behind a common office window. Light having a wavelength of 1.55 micron or less passes through most common glasses without much attenuation. This is not the case for Mid-IR wavelengths which are nearly completely absorbed in a common piece of glass.

In consideration of this problem, Mid-IR FSO systems for deployment in office buildings or homes may adopt either of the following strategies: rooftop mount of a weatherized optics head; through-the-wall coupler; and through-the-window coupler.

Rooftop

A ‘weatherized’ optics head can be arranged such that the device would be appropriate for mounting on the rooftop. The housing should be durable and corrosion resistant. In addition, the mount would be carefully arranged with respect to effects of the wind and other sources of vibration. In some mount settings, a shade for blocking the sun's rays from glancing incidence with aperture may be used. From the interior of the weatherized head, apparatus to bring either copper or fiber from rooftop to building interior provides a hard link.

Where a rooftop device is not desirable, for example when a user can not establish rooftop rights, other opportunities exist for bringing an optics head directly into a building interior.

Through-the-Window Couplers

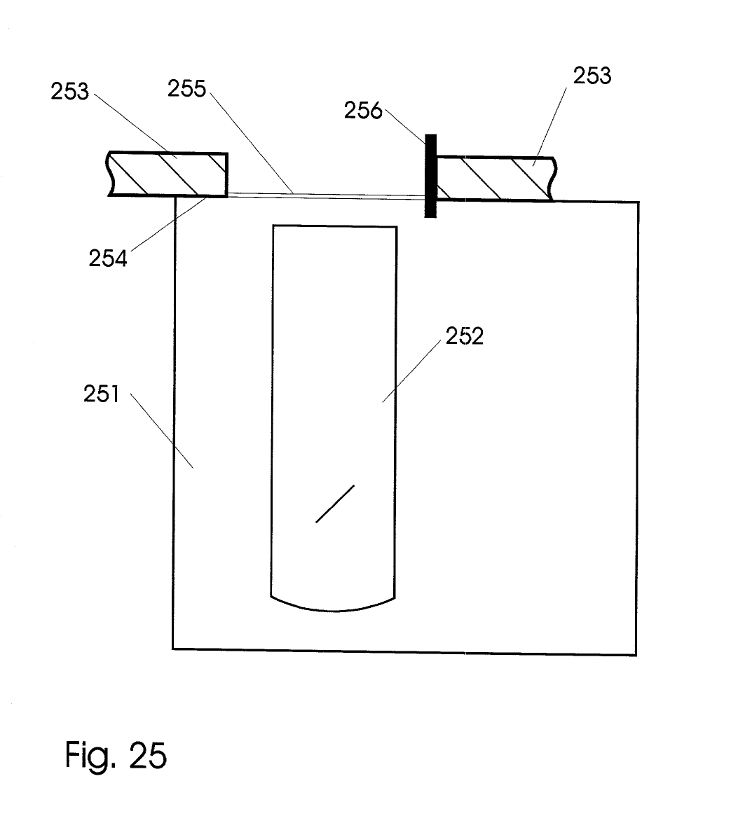

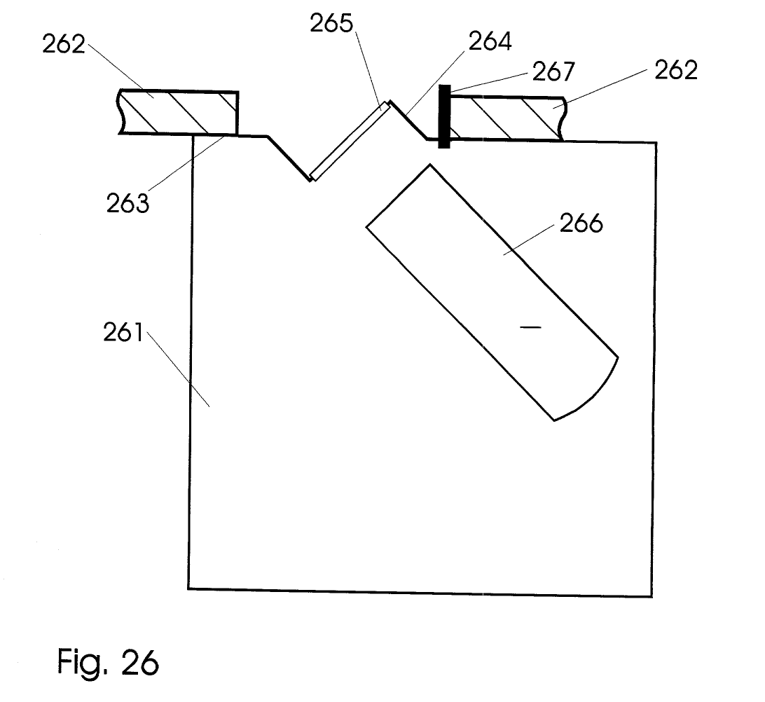

FIGS. 25 and 26 illustrate some special versions of through-the-window type couplers. These couplers can be used in conjunction with a normal glass window found in offices and homes and such. As a glass window will not pass Mid-IR light, it needs to be modified. A hole, perhaps a few inches in diameter is easily cut into a pane of glass with appropriate glass cutting tools. The housing of an optics head can be directly fastened over the hole cut into the glass. The housing can offer structural integrity to the pane which would otherwise be weakened from having a hole cut therein. Further, the hole may thereafter be covered by a special Mid-IR transparent window. The optics head is thereby in good communication with the air column without interference from the glass window.

To some, it may be apparent that putting a hole in the window of a high-rise building presents difficulties with regard to pressure differentials between the interior and exterior of a building which may be large. This can be especially problematic where a thin film type Mid-IR window is used. For this reason, among others, preferred versions have a housing that is pressure sealed to the interior of the glass pane. The interior of the optics head could be equalized with the building exterior pressure by way of a vent. Thus, pressure differentials between the interior and exterior of a building would exist across the housing rather than the thin film window. Pressure differentials across the housing would be harmless as that housing is readily made quite strong.

This becomes very clear in view of the diagram presented as FIG. 25. An optics head 251 contains therein a telescope 252 and other optics. The optics head housing and the interior surface of a building window 253 with a hole cut therein form a pressure seal at joint 254. A Mid-IR window of the thin film type 255 covers the hole cut into the glass pane. A vent 256 can be arranged to allow the interior of the optics head to have the same pressure as the building exterior thus relieving the Mid-IR window of a strength requirement.

Where aiming issues arise such as aiming at an angle which is far from the window normal, through-the-window couplers can be fashioned to address these difficulties. FIG. 26 illustrates a special through-the-window coupler. Optics head 261 is affixed to window having a hole therein 262 at pressure sealed joint 263. Angle bracket 264 holds Mid-IR window 265 with an angular bias with respect to the surface of the glass pane such that telescope 266 receives a good angular view of a transceiver far away in a direction different that the glass window normal. The interior of the optics head may be pressure matched to the building exterior by vent 267.

Through-the-Wall Couplers

A through-the-wall coupler is similar to a window coupler but is installed in the wall which separates the interior of a building from the exterior. Where buildings are not made entirely of glass, it may be preferable to cut through a wall structure rather than glass. An optics head can be installed in a cavity built into a wall at a building side. The Mid-IR window promotes receiving beams of these systems at the optics head for proper detection. Thereafter, the signal can be transferred and passed to the interior of the building via various means including near-IR, cable, fiber, et cetera. A through-the-wall coupler exposes a system Mid-IR detector to an air column on the exterior of a building into which the coupler is mounted. The coupler additionally allows the signal, albeit in a converted state, to be passed to the building interior.

One will now fully appreciate how a free space optics communication system can provide tremendous advantage for conveying information in an atmosphere otherwise unsuitable for optical transmissions. Although present inventions have been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

What is claimed is:

1) An optical communications link for conveying encoded information comprising a plurality of nodes including at least two terminal stations; and at least one air column optical path, said terminal stations each comprising a transceiver having an optic axis aligned with the optic axis of another transceiver whereby the optical transceivers communicate with each other via optical beams arranged to propagate in said at least one air column optical path, said optical beams comprising modulated radiation characterized as middle infrared optical radiation whereby said optical beams tend to resist being disturbed and attenuated by atmospheric components such as pollution and fog thereby providing a failure resistant communications link.

2) An optical communications link of claim 1, said air column is less than 500 meters from Earth's surface and is substantially horizontal.

3) An optical communications link of claim 2, said air column is a cylindrical body having a symmetry axis and comprises a low Earth atmosphere volume containing an air mass.

4) An optical communications link of claim 3, said air column is comprised of concentrations of matter which tend to absorb or scatter, or otherwise attenuate optical radiation.

5) An optical communications link of claim 4, said air column optical path has a length greater than two hundred meters.

6) An optical communications link of claim 5, said air column optical path has a length greater than about two hundred meters and less than about ten thousand meters.

7) An optical communications link of claim 6, said air column optical path comprising a density of water to cause optical attenuation greater than 300 dB per kilometer for a beam having a wavelength of 2 microns.

8) An optical communications link of claim 6, said air column optical path comprising a density of water to cause optical attenuation greater than 300 dB per kilometer for a beam having a wavelength of 1 microns.

9) An optical communication link of claim 6, said water content is in the form of fog.

10) An optical communications link of claim 6, said air column optical path comprising a density of water to cause ‘visibility’ to be less than 1 mile.

11) An optical communications link of claim 4, said free space optical path includes therewithin components from the group: air, gases, pollution, particulate, dust, and air and gas currents, and temperature gradients.

12) An optical communications link of claim 4, said free space optical path has transmission characteristics including artifacts known as ‘atmospheric windows’.

13) An optical communications link of claim 4, said air column optical path is further characterized in that the ratio of atmospheric attenuation for optical beams of less than about 2 microns to atmospheric attenuation for optical beams of greater than about 5 micron is greater than one.

14) An optical communications link of claim 4, said air column optical path has at least one spatial discontinuity.

15) An optical communications link of claim 14, said air column optical path is discontinuous and folded by way of a relay element.

16) An optical communications link of claim 14, said air column optical path includes a plurality of path elements and discontinuities therebeween.

17) An optical communications link of claim 1, said optical beams are highly collimated and spatially coherent, coupled into said air column whereby said collimated beam propagates therethrough said air column with low diffraction losses.

18) An optical communications link of claim 17, said optical beam is cylindrical having an asymmetric cross section.

19) An optical communications link of claim 18, said optical beam cross section having a plurality of off-axis circular voids therein.

20) An optical communications link of claim 19, said circular voids are arranged to accommodate telescope space sharing.

21) An optical communications link of claim 20, said optical beam having an intensity profile aligned to telescope space pass region whereby beam energy is efficiently coupled to an asymmetric telescope space.

22) An optical communications link of claim 1, said optical beams being comprised of optical radiation between about 3 and 20 micrometers in wavelength.

23) An optical communications link of claim 22, said optical beams being comprised of optical radiation between about 4 and 7 micrometers in wavelength or those wavelengths which might be characterized and associated with the first atmospheric window.

24) An optical communications link of claim 22, said optical beams being comprised of optical radiation between about 9 and 12 micrometers in wavelength or those wavelengths which might be characterized and associated with the second atmospheric window.

25) An optical communications link of claim 22, said optical beams being comprised of optical radiation having a wavelength associated with CO₂ laser lines including isotopes thereof.

26) An optical communications link of claim 22, said optical beams being comprised of optical radiation having a wavelength associated with isotopic CO₂ laser lines whereby beam attenuation from atomic CO₂ resonances is reduced in said air column.

27) An optical communications link of claim 22, said optical beams being comprised of optical radiation from a quantum cascade laser.

28) An optical communications link of claim 27, said optical beams being comprised of optical radiation having a linewidth greater than 50 nanometers.

29) An optical communications link of claim 22, said optical beams being comprised of optical radiation of a plurality of wavelengths or center frequencies.

30) An optical communications link of claim 29, where the plurality of center frequencies are discrete and spaced apart whereby they may be resolved in a spectral dispersion element.

31) An optical communications link of claim 1, said transmitter further comprises a housing to enclose optics, shield against environmental elements and provide temperature stability; and an aperture normal to the transmitter optic axis therein said housing.

32) As optical communications link of claim 31, said transmitter further comprises a Mid-IR window substantially covering said aperture whereby optical radiation in the middle infrared spectral region passes from the transmitter interior to an air column exterior to the transmitter.

33) An optical communications link of claim 32, said Mid-IR window is a thin film material.

34) An optical communications link of claim 32, said Mid-IR window is a material of appreciable thickness but transparent to Mid-IR wavelengths such as germanium, zinc selenide, or cadmium telluride.

35) An optical communications link of claim 1, said optical transceiver further comprising an optical beam source arranged to produce radiation in the middle infrared spectral region.

36) An optical communications link of claim 35, said optical beam source further comprising a laser arranged to oscillate and amplify radiation in the middle infrared spectral region.

37) An optical communications link of claim 36, said laser is further defined as a solid state semiconductor laser.

38) An optical communications link of claim 37, said laser is further defined as a solid state semiconductor laser comprising structures known as quantum wells.

39) An optical communications link of claim 38, said laser is further defined as a ‘type-II’ quantum well device arranged with adjacent quantum wells to support intraband transitions.

40) An optical communications link of claim 38, said laser is further defined as a quantum well device arranged with quantum wells to support intrasubband lasing transitions.

41) An optical communications link of claim 40, said laser is further defined as having a two phonon type relaxation mechanism arranged to depopulate the lower lasing energy state.

42) An optical communications link of claim 38, said laser is a quantum cascade laser arrange to lase on a plurality of lasing lines.

43) An optical communications link of claim 35, said optical beam source is a plurality of quantum cascade lasers.

44) An optical communications link of claim 35, said optical beam source is a gas laser.

45) An optical communications link of claim 44, said laser is further defined as a CO₂ laser.

46) An optical communications link of claim 45, said laser is further defined as a CO₂ waveguide laser.

47) An optical communications link of claim 45, said laser is further defined as a radio frequency pumped CO₂ laser.

48) An optical communications link of claim 45, said laser is further defined as a folded cavity waveguide laser.

49) An optical communications link of claim 45, said laser is further defined as a C₁₃O₂¹⁶ gas laser running on the R(18) line.

50) An optical communications link of claim 45, said laser is further defined as a laser operating simultaneously on a plurality of lasing lines.

51) An optical communications link of claim 35, said optical beam source is a plurality of CO₂ gas lasers.

52) An optical communications link of claim 1, said transmitter further comprises a modulation means for encoding an optical carrier beam in agreement with an electronic input signal presented as a transceiver input.

53) An optical communications link of claim 52, said modulation means is further defined as very fast drive electronics to supply electrical signals directly to a quantum cascade laser.

54) An optical communications link of claim 53, said modulation means is a fast switching current source in close proximity to the laser.

55) An optical communications link of claim 54, said current source has a bandwidth between 0.1 and 5 GHz.

56) An optical communications link of claim 52, said modulation means is an optical apparatus arranged to interrupt optical beams, the optical apparatus having an axis, input and output apertures, modulation medium and an electronic input.

57) An optical communications link of claim 56, said optical apparatus is responsive to electrical signals applied to the electronic input and operates on optical beams therein.

58) An optical communications link of claim 56, said optical apparatus is coupled to an output beam of said optical beam source whereby the beam passes through the input aperture, modulation medium, and output aperture.

59) An optical communications link of claim 58, said optical apparatus is operable for modulating said beam with information by causing said beam to exist in two states: an ‘on’ state and an ‘off’ state.

60) An optical communications link of claim 56, said optical transceiver further comprising an optical modulator operable in the medium IR spectral region.

61) An optical communications link of claim 60, said optical modulator having a bandwidth greater than 100 MHz.

63) An optical communications link of claim 52, said modulation means comprising a solid state crystal asymmetrically deformable under applied electronic fields with respect to a crystalline axis.

64) An optical communications link of claim 63, said crystal being comprised of material from the group including CdTe, GaAs, AlGaAs, ZnSe and ZnS.

67) An optical communications link of claim 63, said crystal is CdTe crystal having at least one cross sectional dimension of about 100 microns.

65) An optical communications link of claim 63, said crystal forms a Mach-Zehnder type interferometer in two optical paths; either of said paths having modulation electrodes in proximity therewith.

66) An optical communications link of claim 63, said crystal forms a waveguide structure.

67) An optical communications link of claim 52, said modulation means employing a Stark effect mechanism whereby an optical beam is coupled to a highly absorptive gas having a resonance near the frequency of the optical beam.

69) An optical communications link of claim 67, said gas is deuterated ammonium.

70) An optical communications link of claim 67, said gas is methyl-chloride;

71) An optical communications link of claim 67, said modulation means is a N₁₄H₃ Stark Cell.

72) An optical communications link of claim 1, said transmitter further comprises a plurality of modulation means for encoding optical carrier beams in agreement with electronic input signals presented as a transceiver input.

73) An optical communications link of claim 72, each of said modulation means in the plurality operate independently on a separate laser spatially displaced from other lasers to effect a spatial division multiplexing scheme.

74) An optical communications link of claim 72, each of said modulation means in the plurality operate independently on a separate optical beam of various wavelength to effect a wavelength division multiplexing scheme.

75) An optical communications link of claim 1, each transceiver further comprises a receiver portion comprising at least one optical detector.

76) An optical communications link of claim 75, said receiver portion further comprises an optic axis aligned with telescope whereby optical beams incident on telescope are coupled to receiver components; bandpass filter arranged to attenuate light not in a design wavelength; and a condensing lens arranged to focus a received beam onto the active region of a photodetector.

77) An optical communications link of claim 76, said photodetector is a PIN type device.

78) An optical communications link of claim 76, said photodetector is a HgCdTe device.

79) An optical communications link of claim 76, said photodetector is a quantum well infrared photodetector device.

80) An optical communications link of claim 79, said quantum well infrared photodetector includes a prism coupler whereby a beam enters a quantum well stack; reflects via a total internal reflection at a detector surface, and makes a second pass through the quantum well stack for improved coupling.

81) An optical communications link of claim 75, said receiver is comprised of a plurality of detectors.

82) An optical communications link of claim 81, said plurality of photodetectors are arranged in cooperation with dispersion elements to separate wavelengths.

83) An optical communications link of claim 81, said plurality of photodetectors are spatially displaced in support of space division multiplexing scheme.

84) An optical communications link of claim 1, said transceivers having an active steering system.

86) An optical communications link of claim 84, said active steering system comprises a movable mirror driven by a motion transducer in communication with a beam position detection component, said steering systems being coupled together to both a detection optical train and a transmit optical train.

87) An optical communications link of claim 86, said steering system has high angular resolution whereby a received beam maintains coupling with said photodetector over links comprised of 0.2-5 kilometer free space paths.

88) An optical communications link of claim 84, said steering system includes two operational modes, a normal operation mode and a ‘reacquire’ mode comprised of a scan and step routine whereby an alignment between two transceivers can be reacquired.

89) An optical communications link of claim 1, said transceiver further comprising a temperature control means to regulate the temperature of transceiver components.

90) An optical communications link of claim 89, said temperature control means further comprising three independent heat sinks; a laser heat sink, a detector heat sink and an optics head heat sink, each of the three heat sinks being coupled to a master heat sink via a liquid flow path.

91) An optical communications link of claim 90, said liquid flow path passing from an optics head to a separated cooling unit comprising mechanical compressor and refrigerant cooling hardware.

92) An optical communications link of claim 90, said laser heat sink is a two stage high heat capacity thermoelectric cooler operable for maintaining a quantum cascade laser at −30° C.; said detector heat sink is a four stage thermoelectric cooler operable for maintaining a QWIP detector at −70° C.; and said optics head heat sink is operable for maintaining an optics head at −15° C.

93) An optical communications link of claim 1, said transceivers further comprising a coupling window providing isolation and an environmental barrier between optical components of said transceivers and said air column optical path, whereby said coupling window passes light of Mid-IR wavelengths but restricts particulate matter in said air column from entering a transceiver enclosure containing optical components.

94) An optical communications link of claim 93, said coupling window is a thin film.

95) An optical communications link of claim 93, said coupling window is a Mid-IR transparent crystal material of appreciable thickness.

96) An optical communications link of claim 95, crystal is from the group: Ge, CdTe, ZnSe, ZnS, and GaAs.

97) An optical communications link of claim 93, coupling window is a molded substrate of plastic material.

98) An optical communications link of claim 93, said window has thereon anti-reflection coatings to optimize reflections and transmission properties of the element.

99) An optical communications link of claim 1, said transceiver is comprised of a transmitter portion including a plurality of optical beam sources each of a different wavelength and a receiver portion having a plurality of detector optical trains responsive to different wavelengths.

100) An optical communications link of claim 99, said plurality of optical beams of different wavelength are produced in a shingle laser.

101) An optical communications link of claim 99, said transmitter portion being comprised of a plurality of lasers each tuned to a different wavelength.

102) An optical communications link of claim 101, said plurality of laser being quantum cascade lasers at different wavelengths.

103) An optical communications link of claim 1, said transceiver is comprised of a transmitter portion including a plurality of optical beam sources each separated from the others spatially, and a receiver portion having a plurality of detector optical trains each separated from the others spatially.

104) An optical communications link of claim 103, further including a wavelength division multiplexing scheme whereby each space division channel comprises a plurality of optical beam sources each at different wavelengths.

105) An optical communications link of claim 1, said transceivers are coupled in asymmetric pairs including a first transceiver with an optical beam source and a second with a retroreflection modulator.

106) An optical communications link of claim 105, said asymmetric transmitter pair providing a bi-directional communications link where the optical beam source is modulated either by a local modulation means or by the retroreflection modulator depending upon which direction information is to be conveyed.

107) An optical communications link of claim 1, further comprising discontinuous air column optical path of two portions and a relay element therebetween.

108) An optical communications link of claim 107, said relay element includes an active steering system.

109) An optical communications link of claim 107, said relay element includes optical beam amplification means.

110) An optical communications link of claim 107, said relay is operative to deflect an optical beam via either from the group of grating, mirror, hologram, kinoform, or acousto-optical modulator.

111) An optical communications link for conveying encoded information comprising a plurality of nodes including a terminal station pair; and at least one air column optical path, a first terminal station comprising a transmitter and a second comprising a receiver, both said transmitter and receiver having an optic axis aligned with the optic axis of the other whereby the nodes communicate in a single direction via optical beams arranged to propagate in said at least one air column optical path, said optical beams comprising modulated radiation characterized as middle infrared optical radiation whereby said optical beams tend to resist being disturbed and attenuated by atmospheric components such as pollution and fog thereby providing a failure resistant communications link.

112) An optical communications link of claim 107, further comprising a return communication path of conventional means such as a network ‘dial-up’ connection for a low bandwidth uplink.

113) An optical communications link of claim 1, at least one terminal station includes a high power optical beam source multiplexed to a plurality of said air column optical paths.

114) An optical communications link of claim 113, said multiplexed optical beam source being coupled to a plurality of independent modulation means.

115) An optical communications link of claim 113, said high power optical beam source is a carbon dioxide gas laser having an output beam split into a plurality of beams each being coupled to a different air column optical path.

116) An optical communications link comprising at least two transceivers, each transceiver having an optic axis aligned with the optic axis of another transceiver, said transceivers comprising:
a telescope;
a steering means;
an optical beam source;
a modulation means; and
a detector,
the telescope having a symmetry axis defining the transceiver optic axis, and being coupled optically to said steering means,
the steering means being operable for aligning optical trains in an optics head with respect to the optical trains of other transceivers, including a local receive optical train with respect to a transmit optical train of a remote transceiver, and a local transmit optical train with respect to a remote receive optical train;
the optical beam source being coupled to the modulation means and the local transmit optical train, the optical beam source and modulation means together being operable for producing an encoded optical beam of Mid-IR wavelengths, and
the detector being a photodetector operable for converting photon input into electronic signals, the detector being coupled via a condenser lens to the local receive optical train whereby optical beams received at the telescope are passed to and incident upon the detector.

117) An optical communications link of claim 116, further comprising:
input and output facilities;
an enclosure w/window; and
temperature regulation means,
the input facilities comprising means for receiving digital electronic signals and coupling those to said modulation means,
the output facilities comprising means for conditioning a detector signal and presenting it as a digital electronic signal in a standard protocol,
the enclosure comprising a durable housing with an aperture aligned with the telescope and a Mid-IR window covering over said aperture, and
the temperature regulation means comprising a master heat sink thermally coupled to a detector heat sink, a optical beam source heat sink, and a optics head heat sink whereby the temperature of three elements may be separately controlled and regulated.

118) An optical communications link of claim 117, said optical beam source comprises a quantum cascade laser and said modulation means is a switched current source connected to the input facilities whereby digital signals received at the input facilities are converted to a modulated optical beam of wavelength between 3 and 20 microns.

119) An optical communications link of claim 117, said optical beam source comprises a carbon dioxide laser and said modulation means is an electro-optic effect type crystal modulator connected to the input facilities whereby digital signals received at the input facilities are converted to a modulated optical beam of wavelength between 3 and 20 microns.

120) An optical communications link of claim 118, said detector is a thermo-electrically cooled quantum well type infrared photodetector with a prism optical coupler connected to the output facilities whereby optical pulses received at the transceiver are converted to digital signals in agreement with standard network transmit protocol.

121) An optical communications link of claim 119, said carbon dioxide gas laser is further defined as a compact, sealed, radio frequency pumped device.

122) An optical communications link of claim 116, the steering means being a movable mirror affixed to a motion transducer driven by a steering feedback signal from a quad type position detector, the steering system being simultaneously coupled to optical trains including said local receive optical train and local transmit optical train.
